(19) United States
(12) Patent Application Publication
(10) Pub. No.: US 2015/0031785 A1
(43) Pub. Date: Jan. 29, 2015

(54) ADHESIVE COMPOSITION AND ADHESIVE SHEET

(71) Applicant: LINTEC CORPORATION, Itabashi-ku, Tokyo (JP)

(72) Inventor: Yumiko Amino, Itabashi-ku (JP)

(73) Assignee: LINTEC CORPORATION, Itabashi-ku, Tokyo (JP)

(21) Appl. No.: 14/387,605

(22) PCT Filed: Mar. 26, 2013
(86) PCT No.: PCT/JP2013/058854

§ 371 Date: Sep. 24, 2014

(30) Foreign Application Priority Data
Mar. 30, 2012 (JP) 2012-081240
Mar. 30, 2012 (JP) 2012-081251
Mar. 30, 2012 (JP) 2012-081264

(51) Int. Cl. C09J 11/06; C09J 7/00; C08K 5/357; C08K 5/1545; C09J 133/08; C08K 5/45

(52) U.S. Cl. CPC C09J 11/06; C09J 133/08; C08K 5/45; C08K 5/357; C08K 5/1545; C09J 7/00; C09J 2433/00; C09J 2201/606
USPC 523/122; 524/84; 524/89; 524/110

(57) ABSTRACT

A pressure-sensitive adhesive composition containing an acrylic copolymer (A) having a structural unit (a1) derived from an alkyl (meth)acrylate (a1)′ and a structural unit (a2) derived from a functional group-containing monomer (a2)′, a crosslinking agent (B), and a photochromic dye (C) selected from a group consisting of dithienylethene-based compounds, oxazine-based compounds and naphthopyran-based compounds has a relatively rapid rate of color change from colored to colorless after termination of irradiation with UV rays, has excellent photochromic performance and can be a pressure-sensitive adhesive layer of a colorless pressure-sensitive adhesive sheet.

### TECHNICAL FIELD

The present invention relates to a reversibly color-changeable, light-transmissive, pressure-sensitive adhesive composition, and to a pressure-sensitive adhesive sheet having a pressure-sensitive adhesive layer formed of the pressure-sensitive adhesive composition.

### BACKGROUND ART

Heretofore, for glass and transparent resin plates for windowpanes, wall surfaces, partitions, for glass and transparent resin plates for illuminations to be used in space exposed to black light irradiation, for vehicles such as cars, buses, trans, etc., and for lenses such as those for sunglasses, eye glasses etc., a color sheet has been proposed for use for light transmission control.

However, use of such a color sheet, for example, as stuck to windowpanes of ordinary constructions, involves a problem in that the quantity of external light that would pass through the sheet in rainy or cloudy days or during evening hours is small since the sheet itself is colored, and therefore sufficient brightness could not be secured inside the constructions.

Recently, for solving the problem, a color sheet using a photochromic dye has been proposed (see PTL 1 to 5). The photochromic dye reversibly changes the color thereof depending on light irradiation. In other words, the photochromic dye has a characteristic of such that it colors when having received sunlight or UV rays from black light or the like, but on the other hand, it gets back to be colorless in the environment not exposed to UV rays.

The color sheet disclosed in PTL 1 to 5 uses a photochromic dye having such a characteristic, and therefore it is said that the sheet can block light only in the environment exposed to UV rays, but is transparent in the other environments.

### CITATION LIST

### Patent Literature

PTL 1: JP-UM-A 2-33002
PTL 2: JP-A 9-32439
PTL 3: JP-A 10-39134
PTL 4: JP-UM-B 6-36236
PTL 5: JP-A 10-330708

### SUMMARY OF INVENTION

### Technical Problem

However, of the color sheet disclosed in PTL 1 to 5, the speed of color change from colored to colorless after termination of irradiation with UV rays is low and, depending on the constituent components thereof, the color sheet may be kept colored even before irradiation with UV rays and is therefore often unsuitable to use that requires transparency.

In addition, the color sheet using a pressure-sensitive adhesive composition containing an ordinary acrylic copolymer, as disclosed in PTL 5, has another problem in that, after long-term use, the colored state is often kept all the time even in UV rays-free environments, that is, the weather resistance of the color sheet is lowered, and still another problem in that the photochromic performance (chromogenicity) of the color sheet is lowered.

The present invention has been made for the purpose of solving the above-mentioned problems, and its object is to provide a pressure-sensitive adhesive composition having a relatively rapid rate of color change from colored to colorless after termination of irradiation with UV rays, having excellent photochromic performance and capable of being a colorless pressure-sensitive adhesive sheet, and a pressure-sensitive adhesive sheet.

### Solution to Problem

The present inventors have found that a pressure-sensitive adhesive composition containing a photochromic dye selected from a specific group of compounds along with an acrylic copolymer having specific structural units and a crosslinking agent can solve the above-mentioned problems, and have completed the present invention.

Specifically, the present invention provides the following [1] to [9].

[1] A pressure-sensitive adhesive composition containing an acrylic copolymer (A) having a structural unit (a1) derived from an alkyl (meth)acrylate (a1)′ and a structural unit (a2) derived from a functional group-containing monomer (a2)′, a crosslinking agent (B), and a photochromic dye (C) selected from a group consisting of dithienylethene-based compounds, oxazine-based compounds and naphthopyran-based compounds.
[2] The pressure-sensitive adhesive composition according to the above [1], wherein the component (A) is an acrylic copolymer (A-1) having a structural unit (a1) derived from an alkyl (meth)acrylate (a1)′ and a structural unit (a2) derived from a functional group-containing monomer (a2) in which a content of a structural unit derived from a carboxyl group-containing monomer and a content of a structural unit derived from a primary amino group-containing monomer are respectively 1.5% by mass or less,

the component (C) is a photochromic dye (C-1) of a dithienylethene-based compound, and a content of the component (C-1) is from 0.40 to 8.00 parts by mass relative to 100 parts by mass of the acrylic copolymer (A-1).

[3] The pressure-sensitive adhesive composition according to the above [2], wherein a content of the structural unit (a2) derived from the functional group-containing monomer (a2)′ in the acrylic copolymer (A-1) is from 0.01 to 35% by mass of all the structural units of the acrylic copolymer (A-1).
[4] The pressure-sensitive adhesive composition according to the above [1], wherein the component (A) is an acrylic copolymer (A-2) having a structural unit (a1) derived from an alkyl (meth)acrylate (a1)′ and a structural unit (a2) derived from a functional group-containing monomer (a2) in which a content of a structural unit derived from a carboxyl group-containing monomer and a content of a structural unit derived from a primary amino group-containing monomer are respectively 3.0% by mass or less,

the component (C) is a photochromic dye (C-2) of an oxazine-based compound, and a content of the component (C-2) is from 0.40 to 8.00 parts by mass relative to 100 parts by mass of the acrylic copolymer (A-2).

[5] The pressure-sensitive adhesive composition according to the above [4], wherein a content of the structural unit (a2) derived from the functional group-containing monomer (a2)′ in the acrylic copolymer (A-2) is from 0.01 to 35% by mass of all the structural units of the acrylic copolymer (A-2).
[6] The pressure-sensitive adhesive composition according to the above [1], wherein the component (A) is an acrylic copolymer (A-3) having a structural unit (a1) derived from an alkyl (meth)acrylate (a1)′ and a structural unit (a2) derived from a functional group-containing monomer (a2) in which a content of a structural unit derived from a carboxyl group-containing monomer is 8.0% by mass or less, a content of a structural unit derived from a primary amino group-containing monomer is 1.5% by mass or less, and a content of the structural unit (a2) is 0.5% by mass or more,

the component (C) is a photochromic dye (C-3) of a naphthopyran-based compound, and a content of the component (C-3) is from 1.50 to 8.00 parts by mass relative to 100 parts by mass of the acrylic copolymer (A-3).

[7] The pressure-sensitive adhesive composition according to the above [6], wherein a content of the structural unit (a1) is from 55 to 99.5% by mass and a content of the structural unit (a2) is from 0.5 to 35% by mass, relative to all the structural units of the acrylic copolymer (A-3).
[8] The pressure-sensitive adhesive composition according to any of the above [1] to [7], wherein the functional group-containing monomer (a2)′ is a hydroxy group-containing monomer.
[9] A pressure-sensitive adhesive sheet having a pressure-sensitive adhesive layer formed of the pressure-sensitive adhesive composition of any of the above [1] to [8].

### Advantageous Effects of Invention

The pressure-sensitive adhesive sheet having a pressure-sensitive adhesive layer formed of the pressure-sensitive adhesive composition of the present invention has a relatively rapid rate of color change from colored to colorless after termination of irradiation with UV rays, has excellent photochromic performance and can be a colorless pressure-sensitive adhesive sheet.

### BRIEF DESCRIPTION OF DRAWING

FIG. 1 This includes cross-sectional views showing one example of the configuration of the pressure-sensitive adhesive sheet of the present invention.

### MODES FOR CARRYING OUT THE INVENTION

In the following description, for example, “(meth)acrylate” means both acrylate and methacrylate, and the same shall apply to other similar terminologies.

### [Pressure-Sensitive Adhesive Composition]

The pressure-sensitive adhesive composition of the present invention contains an acrylic copolymer (A) having a structural unit (a1) derived from an alkyl (meth)acrylate (a1)′ and a structural unit (a2) derived from a functional group-containing monomer (a2)′, a crosslinking agent (B), and a photochromic dye (C) selected from a group consisting of dithienylethene-based compounds, oxazine-based compounds and naphthopyran-based compounds.

The pressure-sensitive adhesive composition of the present invention may optionally contain any other additive such as an antioxidant, a UV absorbent, etc.

The pressure-sensitive adhesive composition of the present invention contains a photochromic dye (C) selected from a specific group of compounds along with an acrylic copolymer (A) having specific structural units and a crosslinking agent (B). Consequently, the pressure-sensitive adhesive sheet having a pressure-sensitive adhesive layer formed of the pressure-sensitive adhesive composition has a relatively rapid rate of color change from colored to colorless after termination of irradiation with UV rays, has excellent photochromic performance and can be a colorless pressure-sensitive adhesive sheet.

The pressure-sensitive adhesive composition of the present invention can be given further excellent characteristics of enhanced weather resistance and resistance to photochromic performance degradation through irradiation with UV rays, by controlling the content of the predetermined structural units in the acrylic copolymer (A) and controlling the content of the component (C) in accordance with the type of the photochromic dye (C) to be contained therein.

The pressure-sensitive adhesive composition of the present invention is preferably any of the following first to third pressure-sensitive adhesive compositions.

### (First Pressure-Sensitive Adhesive Composition)

The first pressure-sensitive adhesive composition of the present invention contains a photochromic dye (C) of a dithienylethene-based compound.

Specifically, the first pressure-sensitive adhesive composition of the present invention contains an acrylic copolymer (A-1) having a structural unit (a1) derived from an alkyl (meth)acrylate (a1)′ and a structural unit (a2) derived from a functional group-containing monomer (a2)′, where a content of a structural unit derived from a carboxyl group-containing monomer and a content of a structural unit derived from a primary amino group-containing monomer are respectively 1.5% by mass or less, and the crosslinking agent (B) and a photochromic dye (C) of a dithienylethene-based compound, in which a content of the photochromic dye (C) is from 0.40 to 8.00 parts by mass relative to 100 parts by mass of the acrylic copolymer (A-1).

The pressure-sensitive adhesive sheet having a pressure-sensitive adhesive layer formed of the first pressure-sensitive adhesive composition has excellent heat resistance, for example, such that even after long-term outdoor use, the photochromic performance thereof is prevented from degrading and the sheet is free from a harmful effect that the discoloration is kept all the time in UV rays-free environments.

### (Second Pressure-Sensitive Adhesive Composition)

The second pressure-sensitive adhesive composition of the present invention contains a photochromic dye (C) of an oxazine-based compound.

Specifically, the second pressure-sensitive adhesive composition of the present invention is a pressure-sensitive adhesive composition containing an acrylic copolymer (A-2) having a structural unit (a1) derived from an alkyl (meth)acrylate (a1)′ and a structural unit (a2) derived from a functional group-containing monomer (a2)′, where a content of a structural unit derived from a carboxyl group-containing monomer and a content of a structural unit derived from a primary amino group-containing monomer are respectively 3.0% by mass or less, a crosslinking agent (B) and a photochromic dye (C) of an oxazine-based compound, in which a content of the photochromic dye (C) is from 0.40 to 8.00 parts by mass relative to 100 parts by mass of the acrylic copolymer (A-2).

The pressure-sensitive adhesive sheet having a pressure-sensitive adhesive layer formed of the second pressure-sensitive adhesive composition has excellent heat resistance, for example, such that even after long-term outdoor use, the photochromic performance thereof is prevented from degrading and the sheet is free from a harmful effect that the discoloration is kept all the time in UV rays-free environments, and has a rapid rate of color change from colored to colorless after termination of irradiation with UV rays.

### (Third Pressure-Sensitive Adhesive Composition)

The third pressure-sensitive adhesive composition of the present invention contains a photochromic dye (C) of a naphthopyran-based compound.

Specifically, the third pressure-sensitive adhesive composition of the present invention is a pressure-sensitive adhesive composition containing an acrylic copolymer (A-3) having a structural unit (a1) derived from an alkyl (meth)acrylate (a1)′ and a structural unit (a2) derived from a functional group-containing monomer (a2)′, a crosslinking agent (B) and a photochromic dye (C) of a naphthopyran-based compound, in which a content of a structural unit derived from a carboxyl group-containing monomer is 8.0% by mass or less, a content of a structural unit derived from a primary amino group-containing monomer is 1.5% by mass or less and a content of the structural unit (a2) is 0.5% by mass or more, relative to all the structural units of the acrylic copolymer (A-3), and in which the content of the photochromic dye (C) is from 1.50 to 8.00 parts by mass relative to 100 parts by mass of the acrylic copolymer (A-3).

The pressure-sensitive adhesive sheet having a pressure-sensitive adhesive layer formed of the third pressure-sensitive adhesive composition has excellent heat resistance, for example, such that even after long-term outdoor use, the photochromic performance thereof is prevented from degrading and the sheet is free from a harmful effect that the discoloration is kept all the time in UV rays-free environments, and has a rapid rate of color change from colored to colorless after termination of irradiation with UV rays.

The acrylic copolymer (A), the crosslinking agent (B), the photochromic dye (C), and other additives that are contained in the pressure-sensitive adhesive compositions (the first to third pressure-sensitive adhesive compositions) of the present invention are described in detail hereinunder.

### [Acrylic Copolymer (A)]

The acrylic copolymer (A) for use in the present invention has a structural unit (a1) derived from an alkyl (meth)acrylate (a1)′ (hereinafter this may be referred to as “monomer (a1)′”) and a structural unit (a2) derived from a functional group-containing monomer (a2)′ (this may be referred to as “monomer (a2)′”).

The acrylic copolymer (A) may additionally have a structural unit derived from any other monomer than the monomers (a1)′ and (a2)′.

In the present invention, one or more different types of the acrylic copolymers (A) may be used either singly or as combined.

The weight-average molecular weight (Mw) of the acrylic copolymer (A) is preferably from 180,000 to 1,700,000, more preferably from 200,000 to 1,500,000, even more preferably from 250,000 to 1,000,000, from the viewpoint of adhesive strength improvement.

When the weight-average molecular weight is 180,000 or more, then the cohesive strength of the pressure-sensitive adhesive composition may increase and the composition can have a sufficient adhesive strength. When the weight-average molecular weight is 1,700,000 or less, then the modulus of elasticity of the pressure-sensitive adhesive layer of the formed pressure-sensitive adhesive sheet would not be too high and therefore the adhesive strength thereof can be prevented from lowering.

In the present invention, the weight-average molecular weight (Mw) means a standard polystyrene-equivalent value measured through gel permeation chromatography (GPC), and concretely means the value measured according to the method described in the section of Examples.

The content of the acrylic copolymer (A) is preferably from 70 to 99.5% by mass relative to the total amount of the pressure-sensitive adhesive composition, more preferably from 85 to 99.0% by mass, even more preferably from 90 to 98.0% by mass. When the content is from 70% by mass or more, then the pressure-sensitive adhesive composition can have an excellent adhesive strength.

The acrylic copolymers (A-1) to (A-3) that the first to third pressure-sensitive adhesive compositions of the present invention contain are copolymers prepared by controlling the content of each structural unit in the acrylic copolymer (A) to a value falling within a predetermined range, and are within the scope of the acrylic copolymer (A).

The copolymerization mode of the acrylic copolymer (A) and the acrylic copolymers (A-1) to (A-3) is not specifically defined, including any of a random copolymer, a block copolymer or a graft copolymer.

The structural units in the acrylic copolymer (A) and the acrylic copolymers (A-1) to (A-3) are described in detail hereinunder.

(Structural Unit (a1))

The acrylic copolymer (A) for use in the present invention contains a structural unit (a1) derived from an alkyl (meth)acrylate (a1)′ (monomer (a1)′) from the viewpoint of adhesive strength improvement.

The monomer (a1)′ includes an alkyl (meth)acrylate with an alkyl group having from 1 to 30 carbon atoms, and from the viewpoint of adhesive strength improvement, the monomer is preferably an alkyl (meth)acrylate with an alkyl group having from 4 to 20 carbon atoms, more preferably an alkyl (meth)acrylate with an alkyl group having from 4 to 12 carbon atoms, even more preferably an alkyl (meth)acrylate with an alkyl group having from 4 to 8 carbon atoms.

The alkyl group includes, for example, a methyl group, an ethyl group, a propyl group, a butyl group, an isobutyl group, a pentyl group, a hexyl group, a 2-ethylhexyl group, an octyl group, an isooctyl group, a decyl group, a dodecyl group, a myristyl group, a palmityl group, a lauryl group, a stearyl group, etc.

More concretely, the monomer (a1)′ includes, for example, methyl (meth)acrylate, ethyl (meth)acrylate, propyl (meth)acrylate, butyl (meth)acrylate, isobutyl (meth)acrylate, pentyl (meth)acrylate, hexyl (meth)acrylate, 2-ethylhexyl (meth)acrylate, octyl (meth)acrylate, isooctyl (meth)acrylate, decyl (meth)acrylate, dodecyl (meth)acrylate, myristyl (meth)acrylate, palmityl (meth)acrylate, lauryl (meth)acrylate, stearyl (meth)acrylate, etc.

One alone or two or more of these monomers (a1)′ may be used here either singly or as combined.

Of those, preferred is butyl (meth)acrylate from the viewpoint of adhesive strength improvement.

The content of the butyl (meth)acrylate-derived structural unit in the structural unit (a1) is preferably from 50 to 100% by mass relative to the entire structural unit (a1) in the acrylic copolymer (A), more preferably from 70 to 100% by mass, even more preferably from 80 to 100% by mass, still more preferably from 90 to 100% by mass, from the viewpoint of obtaining a pressure-sensitive adhesive composition capable of expressing a sufficient adhesive strength even when the pressure-sensitive adhesive layer therein is thinned.

The content of the structural unit (a1) is preferably from 55 to 99.99% by mass relative to all the structural units of the acrylic copolymer (A), more preferably from 65 to 99.97% by mass, even more preferably from 68 to 99.9% by mass, still more preferably from 75 to 99.9% by mass, from the viewpoint of obtaining a sufficient adhesive strength.

(Structural Unit (a2))

The acrylic copolymer (A) for use in the present invention contains a structural unit (a2) derived from a functional group-containing monomer (a2)′ (monomer (a2)′) from the viewpoint of adhesive strength improvement.

In the present invention, the “functional group” of the “functional group-containing monomer” here indicates a functional group that can react with the crosslinking agent (B) to be described below, thereby to be a origin of cross-linkage or a functional group having a cross-linkage facilitation effect.

The functional group of the type includes, for example, a carboxyl group, a primary amino group, an amide group, a hydroxy group, an epoxy group, a cyano group, a keto group, a nitrogen element-containing ring, etc.

The monomer (a2)′ includes, for example, a carboxyl group-containing monomer, a primary amino group-containing monomer, an amide group-containing monomer, a hydroxy group-containing monomer, an epoxy group-containing monomer, a cyano group-containing monomer, a keto group-containing monomer, a monomer having a nitrogen atom-containing ring, etc.

As described below, the acrylic copolymer contained in the first to third pressure-sensitive adhesive compositions of the present invention is any of the acrylic copolymers (A-1) to (A-3) in which the content of the structural unit derived from the carboxyl group-containing monomer and the content of that derived from the primary amino group-containing monomer each are controlled to fall within a predetermined range.

The carboxyl group-containing monomer and the primary amino group-containing monomer correspond to the functional group-containing monomer (a2)′.

The carboxyl group-containing monomer includes, for example, ethylenic unsaturated monocarboxylic acids such as acrylic acid, methacrylic acid, crotonic acid, etc.; ethylenic unsaturated dicarboxylic acids such as fumaric acid, itaconic acid, maleic acid, citraconic acid, etc., and their anhydrides; 2-carboxyethyl methacrylate, etc.

The primary amino group-containing monomer includes, for example, aminoethyl (meth)acrylate, aminopropyl (meth)acrylate, etc.

The amide group-containing monomer includes, for example, (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide, N-butoxymethyl(meth)acrylamide, etc.

The hydroxyl group-containing monomer includes, for example, hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, etc.; unsaturated alcohols such as vinyl alcohol, allyl alcohol, etc.

The epoxy group-having monomer includes, for example, glycidyl (meth)acrylate, allyl glycidyl ether, etc.

The cyano group-containing monomer includes, for example, (meth)acrylonitrile, etc.

The keto group-containing monomer includes diacetone(meth)acrylamide, acetone(meth)acrylate, vinyl methyl ketone, vinyl ethyl ketone, allyl acetacetate, vinyl acetacetate, acetacetyl (meth)acrylate, etc.

The monomer having nitrogen atom-containing ring includes, for example, N-vinyl-2-pyrrolidone, N-methylvinylpyrrolidone, N-vinylpiperidone, N-vinylpiperazine, N-vinylpyrazine, N-vinylpyrrole, N-vinylimidazole, N-vinylmorpholine, N-vinylcaprolactam, N-(meth)acryloylmorpholine, etc.

One alone or two or more of these monomers (a2)′ may be used here either singly or as combined.

Of those, from the viewpoint of maintaining cohesive strength and improving adhesive strength, preferred are hydroxyl group-containing monomers; more preferred are hydroxyalkyl (meth)acrylates; and even more preferred are 2-hydroxyethyl (meth)acrylate, and 4-hydroxybutyl (meth)acrylate.

The content of the structural unit (a2) is preferably from 0.01 to 35% by mass relative to all the structural units of the acrylic copolymer (A), more preferably from 0.03 to 32% by mass, even more preferably from 0.1 to 12% by mass, from the viewpoint of expressing a sufficient adhesive strength.

### (Other Structural Units)

The acrylic copolymer (A) may have, as the structural unit therein, a structural unit (a3) derived from any other monomer (a3)′ than the above-mentioned monomers (a1)′ and (a2)′.

The monomer (A3)′ includes, for example, vinyl esters such as vinyl acetate, vinyl propionate, etc.; olefins such as ethylene, propylene, isobutylene, etc.; halogenated olefins such as vinyl chloride, vinylidene chloride, etc.; aromatic vinyl monomers such as styrene, methylstyrene, vinyltoluene, etc.; diene monomers such as butadiene, isoprene, chloroprene, etc.

One alone or two or more of these monomers (a3)′ may be used here either singly or as combined.

The content of the structural unit (a3) is preferably from 0 to 20% by mass relative to all the structural units of the acrylic copolymer (A), more preferably from 0 to 12% by mass, even more preferably from 0 to 7% by mass.

The synthesis method for the acrylic copolymer (A) is not specifically defined, and the copolymer may be synthesized according to a known polymerization method using starting material monomers in the presence or absence of a solvent.

The solvent to be used includes, for example, ethyl acetate, toluene, etc.

A polymerization initiator may be used in the polymerization reaction. The polymerization initiator includes, for example, azobisisobutyronitrile, benzoyl peroxide, etc.

The polymerization condition is not specifically defined, however, the polymerization temperature is preferably from 50 to 90° C. and the reaction time is preferably from 2 to 30 hours.

### <Acrylic Copolymer (A-1)>

The acrylic copolymer (A-1) contained in the first pressure-sensitive adhesive composition of the present invention is a copolymer having a structural unit (a1) derived from an alkyl (meth)acrylate (a1)′ and a structural unit (a2) derived from a functional group-containing monomer (a2)′, in which a content of a structural unit derived from a carboxyl group-containing monomer and a content of a structural unit derived from a primary amino group-containing monomer are respectively 1.5% by mass or less.

In the first pressure-sensitive adhesive composition of the present invention, one or more different types of the acrylic copolymers (A-1) may be used either singly or as combined.

The content of the acrylic copolymer (A-1) is preferably from 70 to 99.5% by mass relative to the total amount of the first pressure-sensitive adhesive composition of the present invention, more preferably from 85 to 99.0% by mass, even more preferably from 90 to 98.0% by mass. When the content is from 70% by mass or more, then the pressure-sensitive adhesive composition can have an excellent adhesive strength.

As the monomers (a1)′ to (a3)′ constituting the acrylic copolymer (A-1), there are mentioned the monomers given hereinabove, and the preferred monomers for those monomers are the same as those given above.

A pressure-sensitive adhesive sheet formed of a pressure-sensitive adhesive composition containing an ordinary acrylic copolymer has a problem in that, when used for a long period of time, the photochromic performance thereof degrades and the colored state thereof is often kept all the time as such even in UV rays-free environments, that is, the weather resistance of thereof degrades.

For solving the above-mentioned problems, the first pressure-sensitive adhesive composition of the present invention contains a specific amount of a photochromic dye of a dithienylethene-based compound and uses the acrylic copolymer (A-1) which is specifically so prepared as to contain the structural unit derived from the carboxyl group-containing monomer and the structural unit derived from the primary amino group-containing monomer each in an amount of 1.5% by mass or less.

The content of the structural unit derived from the carboxyl group-containing monomer in the acrylic copolymer (A-1) is 1.5% by mass or less relative to all the structural units of the acrylic copolymer (A-1), preferably 1.3% by mass or less, more preferably 1.1% by mass or less, even more preferably 0.5% by mass or less, furthermore preferably 0.07% by mass or less, even further more preferably 0.04% by mass or less, from the viewpoint that the pressure-sensitive adhesive composition can have excellent weather resistance such that, even after long-term use, the photochromic performance thereof is prevented from degrading and the composition is free from a problem that the discoloration is kept all the time in UV rays-free environments.

The content of the structural unit derived from the primary amino group-containing monomer is, also from the same viewpoint as above, 1.5% by mass or less relative to all the structural units of the acrylic copolymer (A-1), preferably 1.3% by mass or less, more preferably 1.1% by mass or less, even more preferably 0.5% by mass or less, further more preferably 0.07% by mass or less, even further more preferably 0.04% by mass or less, still further more preferably 0% by mass.

From the viewpoint of improving the adhesive strength of the pressure-sensitive adhesive composition to be obtained, the acrylic copolymer (A-1) may contain a structural unit derived from a carboxyl group-containing monomer and/or a structural unit derived from a primary amino group-containing monomer, within a range not detracting from the advantageous effects of the present invention.

The content of the structural unit derived from the carboxyl group-containing monomer is preferably 0.01% by mass or more relative to all the structural units of the acrylic copolymer (A-1), more preferably 0.02% by mass or more, even more preferably 0.03% by mass or more, from the viewpoint of improving the adhesive strength.

Also from the same viewpoint as above, the content of the structural unit derived from the primary amino group-containing monomer is preferably 0.01% by mass or more relative to all the structural units of the acrylic copolymer (A-1), more preferably 0.02% by mass or more, even more preferably 0.03% by mass or more.

From the above and from the viewpoint of improving the balance of the excellent weather resistance and the adhesive strength of the pressure-sensitive adhesive composition to be obtained, the content of the structural unit derived from the carboxyl group-containing monomer in the acrylic copolymer (A-1) is preferably from 0.01 to 1.5% by mass relative to all the structural units of the acrylic copolymer (A-1), more preferably from 0.02 to 1.3% by mass, even more preferably from 0.03 to 1.1% by mass.

Also from the same viewpoint as above, the content of the structural unit derived from primary amino group-containing monomer in the acrylic copolymer (A-1) is preferably from 0.01 to 1.5% by mass relative to all the structural units of the acrylic copolymer (A-1), more preferably from 0.02 to 1.3% by mass, even more preferably from 0.03 to 1.1% by mass.

The content of the structural unit (a1) in the acrylic copolymer (A-1) is preferably from 55 to 99.99% by mass relative to all the structural units of the acrylic copolymer (A-1), more preferably from 65 to 99.97% by mass, even more preferably from 68 to 99.9% by mass, still more preferably from 75 to 99.9% by mass, from the viewpoint of obtaining a sufficient adhesive strength.

The content of the butyl (meth)acrylate-derived structural unit in the acrylic copolymer (A-1) is preferably from 50 to 100% by mass relative to the entire structural unit (a1) in the acrylic copolymer (A-1), more preferably from 70 to 100% by mass, even more preferably from 80 to 100% by mass, still more preferably from 90 to 100% by mass, from the viewpoint of obtaining a pressure-sensitive adhesive composition capable of expressing a sufficient adhesive strength even when the pressure-sensitive adhesive layer therein is thinned.

The content of the structural unit (a2) in the acrylic copolymer (A-1) is preferably from 0.01 to 35% by mass relative to all the structural units of the acrylic copolymer (A-1), more preferably from 0.03 to 32% by mass, even more preferably from 0.1 to 12% by mass, from the viewpoint of expressing a sufficient adhesive strength.

The content of the structural unit (a2) in the acrylic copolymer (A-1) includes the content of the structural unit derived from the carboxyl group-containing monomer and the content of the structural unit derived from the primary amino group-containing monomer therein, and the upper limit of the content of each of the structural units derived from those monomers is not more than 1.5% by mass, as described above.

The content of the structural unit (a3) in the acrylic copolymer (A-1) is preferably from 0 to 20% by mass relative to all the structural units of the acrylic copolymer (A-1), more preferably from 0 to 12% by mass, even more preferably from 0 to 7% by mass.

The weight-average molecular weight of the acrylic copolymer (A-1) is preferably from 180,000 to 1,500,000, more preferably from 200,000 to 1,200,000, even more preferably from 250,000 to 950,000, from the viewpoint of adhesive strength improvement.

### <Acrylic Copolymer (A-2)>

The acrylic copolymer (A-2) contained in the second pressure-sensitive adhesive composition of the present invention is a copolymer having a structural unit (a1) derived from an alkyl (meth)acrylate (a1)′ and a structural unit (a2) derived from a functional group-containing monomer (a2)′, in which a content of a structural unit derived from a carboxyl group-containing monomer and a content of a structural unit derived from a primary amino group-containing monomer are respectively 3.0% by mass or less.

The second pressure-sensitive adhesive composition of the present invention may contain one or more different types of the acrylic copolymers (A-2) either singly or as combined.

The content of the acrylic copolymer (A-2) is preferably from 70 to 99.5% by mass relative to the total amount of the second pressure-sensitive adhesive composition of the present invention, more preferably from 85 to 99.0% by mass, even more preferably from 90 to 98.0% by mass. When the content is from 70% by mass or more, then the pressure-sensitive adhesive composition can have an excellent adhesive strength.

As the monomers (a1)′ to (a3)′ constituting the acrylic copolymer (A-2), there are mentioned the monomers given hereinabove, and the preferred monomers for those monomers are the same as those given above.

For solving the above-mentioned problems with the second pressure-sensitive adhesive composition of the present invention that, in long-term use, the photochromic performance of the adhesive composition is worsened and the weather resistance thereof is lowered in that the discoloration is kept all the time even in UV rays-free environments, the adhesive composition contains a specific amount of a photochromic dye of an oxazine-based compound and uses the acrylic copolymer (A-2) which is specifically so prepared as to contain the structural unit derived from the carboxyl group-containing monomer and the structural unit derived from the primary amino group-containing monomer each in an amount of 3.0% by mass or less.

The content of the structural unit derived from the carboxyl group-containing monomer in the acrylic copolymer (A-2) is 3.0% by mass or less relative to all the structural units of the acrylic copolymer (A-2), preferably 2.5% by mass or less, more preferably 1.7% by mass or less, even more preferably 1.2% by mass or less, still more preferably 0.5% by mass or less, further more preferably 0.1% by mass or less, still further preferably 0% by mass, from the viewpoint that the pressure-sensitive adhesive composition can have excellent weather resistance such that, even after long-term use, the photochromic performance thereof is prevented from degrading and the composition is free from a problem that the discoloration is kept all the time in UV rays-free environments.

The content of the structural unit derived from the primary amino group-containing monomer in the acrylic copolymer (A-2) is, also from the same viewpoint as above, 3.0% by mass or less relative to all the structural units of the acrylic copolymer (A-2), preferably 2.5% by mass or less, more preferably 1.7% by mass or less, even more preferably 1.2% by mass or less, still more preferably 0.5% by mass or less, further more preferably 0.1% by mass or less, still further preferably 0% by mass.

From the viewpoint of improving the adhesive strength of the pressure-sensitive adhesive composition to be obtained, the acrylic copolymer (A-2) may contain a structural unit derived from a carboxyl group-containing monomer and/or a structural unit derived from a primary amino group-containing monomer, within a range not detracting from the advantageous effects of the present invention.

The content of the structural unit derived from the carboxyl group-containing monomer is preferably 0.01% by mass or more relative to all the structural units of the acrylic copolymer (A-2), more preferably 0.04% by mass or more, even more preferably 0.08% by mass or more, from the viewpoint of improving the adhesive strength.

Also from the same viewpoint as above, the content of the structural unit derived from primary amino group-containing monomer is preferably 0.01% by mass or more relative to all the structural units of the acrylic copolymer (A-2), more preferably 0.04% by mass or more, even more preferably 0.08% by mass or more.

From the above and from the viewpoint of improving the balance of the excellent weather resistance and the adhesive strength of the pressure-sensitive adhesive composition to be obtained, the content of the structural unit derived from the carboxyl group-containing monomer in the acrylic copolymer (A-2) is preferably from 0.01 to 3.0% by mass relative to all the structural units of the acrylic copolymer (A-2), more preferably from 0.04 to 2.5% by mass, even more preferably from 0.08 to 1.7% by mass.

Also from the same viewpoint as above, the content of the structural unit derived from primary amino group-containing monomer in the acrylic copolymer (A-2) is preferably from 0.01 to 3.0% by mass relative to all the structural units of the acrylic copolymer (A-2), more preferably from 0.04 to 2.5% by mass, even more preferably from 0.08 to 1.7% by mass.

The content of the structural unit (a1) in the acrylic copolymer (A-2) is preferably from 55 to 99.99% by mass relative to all the structural units of the acrylic copolymer (A-1), more preferably from 65 to 99.97% by mass, even more preferably from 68 to 99.9% by mass, still more preferably from 75 to 99.9% by mass, from the viewpoint of obtaining a sufficient adhesive strength.

The content of the butyl (meth)acrylate-derived structural unit in the acrylic copolymer (A-2) is preferably from 50 to 100% by mass relative to the entire structural unit (a1) in the acrylic copolymer (A-2), more preferably from 70 to 100% by mass, even more preferably from 80 to 100% by mass, still more preferably from 90 to 100% by mass, from the viewpoint of obtaining a pressure-sensitive adhesive composition capable of expressing a sufficient adhesive strength even when the pressure-sensitive adhesive layer therein is thinned.

The content of the structural unit (a2) in the acrylic copolymer (A-2) is preferably from 0.01 to 35% by mass relative to all the structural units of the acrylic copolymer (A-2), more preferably from 0.03 to 32% by mass, even more preferably from 0.1 to 12% by mass, from the viewpoint of expressing a sufficient adhesive strength.

The content of the structural unit (a2) includes the content of the structural unit derived from the carboxyl group-containing monomer and the content of the structural unit derived from the primary amino group-containing monomer therein, and the upper limit of the content of each of the structural units derived from those monomers is not more than 3.0% by mass, as described above.

The weight-average molecular weight of the acrylic copolymer (A-2) is preferably from 180,000 to 1,500,000, more preferably from 200,000 to 1,200,000, even more preferably from 250,000 to 1,050,000, from the viewpoint of adhesive strength improvement.

### <Acrylic Copolymer (A-3)>

The acrylic copolymer (A-3) contained in the third pressure-sensitive adhesive composition of the present invention is a copolymer having a structural unit (a1) derived from an alkyl (meth)acrylate (a1)′ and a structural unit (a2) derived from a functional group-containing monomer (a2)′, in which a content of a structural unit derived from a carboxyl group-containing monomer is 8.0% by mass or less, a content of a structural unit derived from a primary amino group-containing monomer is 1.5% by mass or less, and a content of the structural unit (a2) is 0.5% by mass or more.

The third pressure-sensitive adhesive composition of the present invention may contain one or more different types of the acrylic copolymers (A-3) either singly or as combined.

The content of the acrylic copolymer (A-3) is preferably from 70 to 99.5% by mass relative to the total amount of the third pressure-sensitive adhesive composition of the present invention, more preferably from 85 to 99.0% by mass, even more preferably from 90 to 98.0% by mass. When the content is 70% by mass or more, then the pressure-sensitive adhesive composition can have an excellent adhesive strength.

As the monomers (a1)′ to (a3)′ constituting the acrylic copolymer (A-3), there are mentioned the monomers given hereinabove, and the preferred monomers for those monomers are the same as those given above.

For solving the above-mentioned problems with the third pressure-sensitive adhesive composition of the present invention that, in long-term use, the photochromic performance of the adhesive composition is worsened and the weather resistance thereof is lowered in that the discoloration is kept all the time even in UV rays-free environments, the adhesive composition contains a specific amount of a photochromic dye of a naphthopyran-based compound and uses the acrylic copolymer (A-3) which is specifically so prepared as to contain 8.0% by mass or less of the structural unit derived from the carboxyl group-containing monomer, 1.5% by mass or less of the structural unit derived from the primary amino group-containing monomer and 0.5% by mass or more of the structural unit (a2).

When the content of the structural unit derived from the carboxyl group-containing monomer is more than 8.0% by mass, then after long-term use, there may occur a harmful effect that the discoloration is kept all the time even in UV rays-free environments.

On the other hand, when the content of the structural unit derived from the primary amino group-containing monomer is more than 1.5% by mass, then the photochromic performance may degrade after long-term use.

The content of the structural unit derived from the carboxyl group-containing monomer in the acrylic copolymer (A-3) is, also from the same viewpoint as above, 8.0% by mass or less relative to all the structural units of the acrylic copolymer (A-3), preferably 6.7% by mass or less, more preferably 5.0% by mass or less, even more preferably 2.0% by mass or less, still more preferably 0.5% by mass or less, further more preferably 0% by mass.

The content of the structural unit derived from the primary amino group-containing monomer in the acrylic copolymer (A-3) is, also from the same viewpoint as above, 1.5% by mass or less relative to all the structural units of the acrylic copolymer (A-3), preferably 1.2% by mass or less, more preferably 0.8% by mass or less, even more preferably 0.5% by mass or less, still more preferably 0.12% by mass or less, further more preferably 0% by mass.

From the viewpoint of improving the adhesive strength of the pressure-sensitive adhesive composition to be obtained, the acrylic copolymer (A-3) may contain a structural unit derived from a carboxyl group-containing monomer and/or a structural unit derived from a primary amino group-containing monomer, within a range not detracting from the advantageous effects of the present invention.

The content of the structural unit derived from the carboxyl group-containing monomer is preferably 0.01% by mass or more relative to all the structural units of the acrylic copolymer (A-3), more preferably 0.03% by mass or more, even more preferably 0.1% by mass or more, from the viewpoint of improving the adhesive strength.

Also from the same viewpoint as above, the content of the structural unit derived from the primary amino group-containing monomer is preferably 0.01% by mass or more relative to all the structural units of the acrylic copolymer (A-3), more preferably 0.03% by mass or more, even more preferably 0.1% by mass or more.

From the above, the content of the structural unit of the carboxyl group-containing monomer is preferably from 0.01 to 8.0% by mass relative to all the structural units of the acrylic copolymer (A-3), more preferably from 0.03 to 6.7% by mass, even more preferably from 0.1 to 5.0% by mass, from the above-mentioned viewpoint.

On the other hand, the content of the structural unit of the primary amino group-containing monomer is preferably from 0.01 to 1.5% by mass relative to all the structural units of the acrylic copolymer (A-3), more preferably from 0.03 to 1.2% by mass, even more preferably from 0.1 to 0.8% by mass, from the above-mentioned viewpoint.

The content of the structural unit (a1) in the acrylic copolymer (A-3) is preferably from 55 to 99.99% by mass relative to all the structural units of the acrylic copolymer (A-3), more preferably from 65 to 99.3% by mass, even more preferably from 68 to 99.0% by mass, still more preferably from 75 to 97.0% by mass, from the viewpoint of obtaining a sufficient adhesive strength.

The content of the butyl (meth)acrylate-derived structural unit in the acrylic copolymer (A-3) is preferably from 50 to 100% by mass relative to the entire structural unit (a1) in the acrylic copolymer (A-3), more preferably from 70 to 100% by mass, even more preferably from 80 to 100% by mass, still more preferably from 90 to 100% by mass, from the viewpoint of obtaining a pressure-sensitive adhesive composition capable of expressing a sufficient adhesive strength even when the pressure-sensitive adhesive layer therein is thinned.

The content of the structural unit (a2) derived from the monomer (a2)′ in the acrylic copolymer (A-3) contained in the third pressure-sensitive adhesive composition of the present invention is preferably 0.5% by mass or more relative to all the structural units of the acrylic copolymer (A-3), more preferably from 0.5 to 35% by mass, even more preferably from 0.7 to 32% by mass, still more preferably from 3.0 to 12% by mass, from the viewpoint of improving the weather resistance of the pressure-sensitive adhesive composition to be obtained and from the viewpoint of expressing a sufficient adhesive strength.

When the content of the structural unit (a2) is less than 0.5% by mass, then the weather resistance of the resultant pressure-sensitive adhesive composition would lower, and especially after long-term use, there may occur various harmful effects that the photochromic performance may degrade and the discoloration may be kept all the time even in UV rays-free environments. On the other hand, when the content is 35% by mass or less, then a sufficient adhesive strength can be expressed and the weather resistance of the resultant pressure-sensitive adhesive composition can be improved.

The content of the structural unit (a2) includes the content of the structural unit derived from the carboxyl group-containing monomer and the content of the structural unit derived from the primary amino group-containing monomer therein.

However, the content of the structural unit derived from the carboxyl group-containing monomer is not more than 8.0% by mass, and the content of the structural unit derived from the primary amino group-containing monomer is not more than 1.5% by mass.

It is desirable that, containing the structural unit derived from the carboxyl group-containing monomer and the structural unit derived from the other monomer (a2)′ than the primary amino group-containing monomer, the content of the structural unit (a2) in the acrylic copolymer (A-3) for use in the present invention is so controlled as to fall within the above-mentioned range.

The weight-average molecular weight of the acrylic copolymer (A-3) is preferably from 180,000 to 1,700,000, more preferably from 200,000 to 1,500,000, even more preferably from 250,000 to 1,000,000, from the viewpoint of adhesive strength improvement.

### [Crosslinking Agent (B)]

From the viewpoint of obtaining the desired adhesive strength by increasing the cohesive strength thereof, the pressure-sensitive adhesive composition of the present invention contains a crosslinking agent (B) capable of reacting with the functional group that the acrylic copolymer (A) (acrylic copolymers (A-1) to (A-3)) has.

The crosslinking agent (B) includes, for example, an isocyanate-based crosslinking agent, an epoxy-based crosslinking agent, an aziridine-based crosslinking agent, a metal chelate-based crosslinking agent, etc.

The isocyanate-based crosslinking agent includes, for example, polyisocyanate compounds such as 2,4-tolylene diisocyanate, 2,6-tolylene diisocyanate, 1,3-xylylene diisocyanate, 1,4-xylylene diisocyanate, diphenylmethane-4,4′-diisocyanate, diphenylmethane-2,4′-diisocyanate, 3-methyldiphenylmethane diisocyanate, hexamethylene diisocyanate, isophorone diisocyanate, dicyclohexylmethane-4,4′-diisocyanate, dicyclohexylmethane-2,4′-diisocyanate, lysine isocyanate, etc.; modified derivatives such as trimethylolpropane adduct modified derivatives of these compounds, biuret modified derivatives obtained by reacting them with water, isocyanurate modified derivatives containing isocyanurate ring, etc.

Not specifically defined, the epoxy-based crosslinking agent may be any and every compound having two or more epoxy groups or glycidyl groups in the molecule. Preferred are polyfunctional epoxy compounds having two or more glycidyl groups in the molecule.

The polyfunctional epoxy compound includes, for example, bisphenol A diglycidyl ether and its oligomers, hydrogenated bisphenol A diglycidyl ether and its oligomers, diglycidyl orthophthalate, diglycidyl isophthalate, diglycidyl terephthalate, glycidyl p-oxybenzoate, diglycidyl tetrahydrophthalate, diglycidyl hexahydrophthalate, diglycidyl succinate, diglycidyl adipate, diglycidyl sebacate, ethylene glycol diglycidyl ether, propylene glycol diglycidyl ether, 1,4-butanediol diglycidyl ether, 1,6-hexanediol diglycidyl ether, polyalkylene glycol diglycidyl ethers, triglycidyl trimellitate, triglycidyl isocyanurate, 1,4-diglycicyloxybenzene, diglycidylpropyleneurea, glycerol triglycidyl ether, trimethylolpropane di- or triglycidyl ether, pentaerythritol di- or triglycidyl ether, glycerol alkylene oxide adduct triglycidyl ethers, diglycidylamines such as diglycidylaniline, etc.

The aziridine-based crosslinking agent includes, for example, 1,1′-(methylene-di-p-phenylene)bis-3,3-aziridinylurea, 1,1′-(hexamethylene)bis-3,3-aziridinylurea, 2,4,6-triaziridinyl-1,3,5-triazine, trimethylolpropane-tris(2-aziridinylpropionate), etc.

The metal chelate-based crosslinking agent includes, for example, acetylacetone, ethyl acetoacetate and the like compounds coordinating to a polyvalent metal such as aluminium, iron, copper, zinc, tin, titanium, nickel, antimony, magnesium, vanadium, chromium, zirconium, etc.

One alone or two or more of these crosslinking agents (B) may be used here either singly or as combined.

Of those, preferred are isocyanate-based crosslinking agents from the viewpoint of expressing high adhesive strength.

The content of the crosslinking agent (B) is preferably from 0.01 to 8 parts by mass relative to 100 parts by mass of the component (A) (components (A-1) to (A-3)), more preferably from 0.05 to 5 parts by mass, even more preferably from 0.1 to 3 parts by mass.

### [Photochromic Dye (C)]

The pressure-sensitive adhesive composition of the present invention contains a photochromic dye (C) selected form dithienylethene-based compounds, oxazine-based compounds and naphthopyran-based compounds.

Containing the photochromic dye selected from the group of compounds mentioned above, the pressure-sensitive adhesive composition of the present invention can be a pressure-sensitive adhesive layer of a colorless pressure-sensitive adhesive sheet that has a relatively rapid rate of color change from colored to colorless after termination of irradiation with UV rays and has excellent photochromic performance.

The content of the component (C) is, from the above-mentioned viewpoint, preferably from 0.40 to 8.00 parts by mass relative to 100 parts by mass of the acrylic copolymer (A), more preferably from 0.50 to 6.00 parts by mass, even more preferably from 0.55 to 4.80 parts by mass.

The composition may contain one alone or two or more different types of these components (C) either singly or as combined, but from the same viewpoint as above, preferably contains a photochromic dye of the same type of compounds.

As the photochromic dye (C), the first pressure-sensitive adhesive composition of the present invention contains a dithienylethene-based compound, the second pressure-sensitive adhesive composition contains an aziridine compound, and the third pressure-sensitive adhesive composition contains a naphthopyran-based compound.

### <Dithienylethene-Based Compound>

The dithienylethene-based compound that the pressure-sensitive adhesive composition of the present invention contains as the component (C) means a compound having a double bond part in the structure and having two thienyl groups, and in the present invention, used is a dithienylethene-based compound having photochromic performance. The structure containing a double bond part may be a part constituting the linear structure, or may be a part constituting a cyclic structure.

The thienyl group may have a substituent such as an alkyl group having from 1 to 20 carbon atoms, a cycloalkyl group having from 3 to 20 carbon atoms, an aryl group having from 6 to 30 carbon atoms, etc.

The dithienylethene-based compound includes, for example, 1,2-bis(2,4-dimethyl-5-phenyl-3-thienyl)-3,3,4,4,5,5-hexafluoro-1-cyclopentene (commercial product; product name “B2629”, by Tokyo Chemical Industry Co., Ltd. (the same shall apply hereinafter)), 1,2-bis[2-methylbenzo[b]thiophen-3-yl]-3,3,4,4,5,5-hexafluoro-1-cyclopentene (commercial product; “B2287”), 2,3-bis(2,4,5-trimethyl-3-thienyl)maleic anhydride (commercial product; “B1534”), cis-1,2-dicyano-1,2-bis(2,4,5-trimethyl-3-thienyl)ethene (commercial product; “B1536”), 2,3-bis(2,4,5-trimethyl-3-thienyl)maleimide (commercial product; “B1535”), etc.

One alone or two or more different types of those dithienylethene-based compounds may be used here either singly or as combined.

From the viewpoint of long-term weather resistance, of those dithienylethene-based compounds, preferred are diarylethene compounds that are compounds having two aryl groups in the structure or hexafluorocyclopentene group-having compounds, and more preferred are hexafluorocyclopentene group-having diarylethene compounds.

The compounds of those types include, for example, 1,2-bis(2,4-dimethyl-5-phenyl-3-thienyl)-3,3,4,4,5,5-hexafluoro-1-cyclopentene, 1,2-bis[2-methylbenzo[b]thiophen-3-yl]-3,3,4,4,5,5-hexafluoro-1-cyclopentene, etc. More preferred are benzothienyl group-having dithienylethene-based compounds such as 1,2-bis[2-methylbenzo[b]thiophen-3-yl]-3,3,4,4,5,5-hexafluoro-1-cyclopentene.

### (Content of Component (C) of Dithienylethene-Based Compound in First Pressure-Sensitive Adhesive Composition)

The first pressure-sensitive adhesive composition of the present invention contains a photochromic dye of a dithienylethene-based compound as the component (C).

The content of the photochromic dye (C) of a dithienylethene-based compound contained in the first pressure-sensitive adhesive composition of the present invention is from 0.40 to 8.00 parts by mass relative to 100 parts by mass of the acrylic copolymer (A-1).

When the content is less than 0.40 parts by mass, the resultant pressure-sensitive adhesive composition could not express sufficient photochromic performance. When the content is more than 8.00 parts by mass, then the weather resistance of the resultant pressure-sensitive adhesive composition would lower, and especially after long-term use, there may occur various harmful effects that the photochromic performance may degrade and the discoloration may be kept all the time even in UV rays-free environments.

The content of the photochromic dye (C) of a dithienylethene-based compound is, from the above-mentioned viewpoint, preferably from 0.50 to 6.00 parts by mass relative to 100 parts by mass of the acrylic copolymer (A-1), more preferably from 0.55 to 4.80 parts by mass, even more preferably from 0.60 to 4.20 parts by mass, still more preferably from 0.65 to 3.40 parts by mass, further more preferably from 0.72 to 3.00 parts by mass.

The first pressure-sensitive adhesive composition may contain any other photochromic dye than the dithienylethene-based compound as the component (C) within a range not detracting from the advantageous effects of the present invention, but preferably the composition contains only the photochromic dye of a dithienylethene-based compound alone.

### <Oxazine-Based Compound>

The oxazine-based compound that the pressure-sensitive adhesive composition of the present invention contains as the component (C) means a compound containing at least a 6-membered hetero ring having each one of an oxygen atom and a nitrogen atom, and in the present invention, used is an oxazine-based compound having photochromic performance.

The oxazine-based compound includes, for example, naphthospirooxazine, etc.

The naphthospirooxazine includes, for example, 1,3,3-trimethylspiro[indoline-2,3′-(3H)-naphtho-(2,1-b)(1,4)-oxazine], 6′-indolino-1,3,3-trimethylspiro[indoline-2,3′-(3H)-naphth o-(2,1-b)(1,4)-oxazine], 5-chloro-1,3,3-trimethylspiro[indoline-2,3′-(3H)-naphtho-(2,1-b)(1,4)-oxazine], 6′-piperidino-1,3,3-trimethylspiro[indoline-2,3′-(3H)-naphtho-(2,1-b)(1,4)-oxazine], 1-benzyl-3,3-dimethylspiro[indoline-2,3′-(3H)-naphtho-(2,1-b)(1,4)-oxazine], 1,3,5,6-tetramethyl-3-ethylspiro[indoline-2,3′-(3H)-naphth o-(2,1-b)(1,4)-oxazine], 1,3,3,5,6-pentamethylspiro[indoline-2,3′-(3H)-naphtho-(2,1-b)(1,4)-oxazine], 1,3,5,6-tetramethyl-3-ethylspiro[indoline-2,3′-(3H)-pyrido-(3,2-f) (1,4)-benzoxazine], etc.

As commercial products, for example, there are mentioned “T1259 (manufactured by Tokyo Chemical Industry Co., Ltd.), etc.

One alone or two or more different types of those oxazine compounds may be used here either singly or as combined.

### (Content of Component (C) of Oxazine-Based Compound in Second Pressure-Sensitive Adhesive Composition)

The second pressure-sensitive adhesive composition of the present invention contains a photochromic dye of an oxazine-based compound as the component (C).

The content of the photochromic dye (C) of an oxazine-based compound contained in the second pressure-sensitive adhesive composition of the present invention is from 0.40 to 8.00 parts by mass relative to 100 parts by mass of the acrylic copolymer (A-2).

When the content is less than 0.40 parts by mass, the resultant pressure-sensitive adhesive composition could not express sufficient photochromic performance. When the content is more than 8.00 parts by mass, then the weather resistance of the resultant pressure-sensitive adhesive composition would lower, and especially after long-term use, there may occur various harmful effects that the photochromic performance may degrade and the discoloration may be kept all the time even in UV rays-free environments.

The content of the photochromic dye (C) of an oxazine-based compound is, from the above-mentioned viewpoint, preferably from 0.50 to 6.00 parts by mass relative to 100 parts by mass of the acrylic copolymer (A-2), more preferably from 0.55 to 4.80 parts by mass, even more preferably from 0.60 to 4.20 parts by mass, still more preferably from 0.65 to 3.40 parts by mass, further more preferably from 0.72 to 3.00 parts by mass.

In addition, when the structural unit of the acrylic copolymer (A-2) in the second pressure-sensitive adhesive composition of the present invention includes a structural unit derived from a primary amino group-containing monomer, the content of the photochromic dye (C) of an oxazine-based compound is preferably 2.50 parts by mass or less relative to 100 parts by mass of the acrylic copolymer (A-2), more preferably 1.80 parts by mass or less, even more preferably 1.30 parts by mass or less, from the viewpoint of improving the above-mentioned weather resistance of the resultant pressure-sensitive adhesive composition.

The second pressure-sensitive adhesive composition may contain any other photochromic dye than the oxazine-based compound as the component (C) within a range not detracting from the advantageous effects of the present invention, but preferably the composition contains only the photochromic dye of an oxazine-based compound alone.

### <Naphthopyran-Based Compound>

The naphthopyran-based compound that the pressure-sensitive adhesive composition of the present invention contains as the component (C) means a compound containing a naphthalene ring and a 6-membered hetero ring having one oxygen atom, and in the present invention, used is a naphthopyran-based compound having photochromic performance.

The naphthopyran-based compound includes, for example, 2,2-diphenylnaphtho-(2,1-b)pyran, 2,2-di(p-methoxyphenyl)naphtho-(2,1-b)pyran, 1,3,3-triphenylspiro[indolin-2,3′-(3H)-naphtho-(2,1-b)-pyran], 1-(2,3,4,5,6-pentamethylbenzyl)-3,3-dimehtylspiro[indoline-2,3′-(3H)-naphtho-(2,1-b)-pyran], 1-(2-nitrobenzyl)-3,3-dimethylspiro[indoline-2,3′-(3H)-naphtho-(2,1-b)-pyran], etc.

As commercial products, for example, there are mentioned “D3197 (manufactured by Tokyo Chemical Industry Co., Ltd.), etc.

One alone or two or more different types of those naphthopyran-based compounds may be used here either singly or as combined.

### (Content of Component (C) of Naphthopyran-Based Compound in Third Pressure-Sensitive Adhesive Composition)

The third pressure-sensitive adhesive composition of the present invention contains a photochromic dye of a naphthopyran-based compound as the component (C).

The content of the photochromic dye (C) of a naphthopyran-based compound contained in the third pressure-sensitive adhesive composition of the present invention is from 1.50 to 8.00 parts by mass relative to 100 parts by mass of the acrylic copolymer (A-3).

When the content is less than 1.50 parts by mass, then the weather resistance of the resultant pressure-sensitive adhesive composition would lower, and especially after long-term use, the photochromic performance may significantly degrade. When the content is more than 8.00 parts by mass, then there may occur another harmful effect that the discoloration may be kept all the time even in UV rays-free environments in addition to the degradation of photochromic performance.

The content of the photochromic dye (C) of a naphthopyran-based compound is, from the above-mentioned viewpoint, preferably from 1.65 to 6.00 parts by mass relative to 100 parts by mass of the acrylic copolymer (A-3), more preferably from 1.90 to 4.80 parts by mass, even more preferably from 2.20 to 4.20 parts by mass, still more preferably from 2.60 to 3.40 parts by mass.

The third pressure-sensitive adhesive composition may contain any other photochromic dye than the naphthopyran-based compound as the component (C) within a range not detracting from the advantageous effects of the present invention, but preferably the composition contains only the photochromic dye of a naphthopyran-based compound alone.

### [Other Additives]

The pressure-sensitive adhesive composition of the present invention may further contain any other additive within a range not detracting from the advantageous effects of the present invention and not interfering with the properties of the composition such as the pressure-sensitive adhesive strength and others.

The other additive includes, for example, tackifier, antioxidant, UV absorbent, light stabilizer, resin stabilizer, filler, pigment, extender, IR absorbent, near-IR absorbent, antiseptic/fungicide, rust preventive, plasticizer, high-boiling-point solvent, etc. One alone or two or more different types of these additives may be used here either singly or as combined.

### (Tackifier)

Preferably, the pressure-sensitive adhesive composition of the present invention may further contain a tackifier from the viewpoint of improving the pressure-sensitive adhesive strength of the resulting pressure-sensitive adhesive composition.

Any known tackifier is usable, but from the viewpoint of bettering the weather resistance of the pressure-sensitive adhesive composition and maintaining the photochromic performance of the composition, preferred is a hydrogenated petroleum resin.

In the present invention, the hydrogenated petroleum resin means one prepared by hydrogenating a petroleum resin such as an aliphatic petroleum resin, an aromatic petroleum resin, a cyclopentadiene-based petroleum resin or the like by the use of a hydrogenation catalyst.

The hydrogenated petroleum resin includes, for example, hydrogenated terpene-based resin, hydrogenated rosin-based and hydrogenated rosin ester-based resin, disproportionated rosin, disproportionated rosin ester-based resin; hydrogenated dicyclopentadiene-based resin and partially-hydrogenated aromatic-modified dicyclopentadiene-based resin, which are hydrogenated resins of C5-based petroleum resins to be obtained through copolymerization of C5 fraction such as pentene, isoprene, piperine, 1,3-pentadiene or the like that forms through thermal cracking of petroleum naphtha; hydrogenated resin produced through hydrogenation of C9-based petroleum resin that forms through copolymerization of C9 fraction such as indene, vinyltoluene, α-methylstyrene or β-methylstyrene or the like which form through thermal cracking of petroleum naphtha; hydrogenated resin produced through hydrogenation of copolymerized petroleum resin of the above-mentioned C5 fraction and C9 fraction, etc.

The content of the tackifier, if any, in the composition is preferably from 5 to 60 parts by mass relative to 100 parts by mass of the component (A) (components (A-1) to (A-3)), more preferably from 10 to 40 parts by mass, even more preferably from 15 to 25 parts by mass. When the content is 5 parts by mass or more, then the adhesive strength of the resultant pressure-sensitive adhesive composition may be further increased. When the content is 60 parts by mass or less, then the pressure-sensitive adhesive layer of the pressure-sensitive adhesive sheet formed of the resultant pressure-sensitive adhesive composition may have sufficient flexibility and may prevent zipping.

### (Antioxidant)

The pressure-sensitive adhesive composition of the present invention may further contain an antioxidant. The antioxidant, if any in the pressure-sensitive adhesive composition of the present invention, does not detract from the photochromic capability of the composition. Containing such an antioxidant, the pressure-sensitive adhesive composition could be more excellent in resistance to high wet heat.

As the antioxidant, preferred is a hindered phenol-based antioxidant from the viewpoint of improving the resistance to high wet heat of the pressure-sensitive adhesive composition, more preferred is a hindered phenol-based antioxidant having a branched alkyl group, and even more preferred is a hindered phenol-based antioxidant in which the two beta positions of the hindered phenol group are both t-butyl groups.

The hindered phenol-based antioxidant in which the two beta positions of the hindered phenol group are both t-butyl groups is excellent in the ability of the antioxidant especially in terms of enhancing the durability in use for long-term operation or in use in outdoor operation environments.

The content of the antioxidant, if any, in the pressure-sensitive adhesive composition of the present invention is preferably from 0.01 to 1.0 part by mass relative to 100 parts by mass of the component (A) (components (A-1) to (A-3)), more preferably from 0.03 to 0.5 parts by mass, even more preferably from 0.04 to 0.3 parts by mass, from the viewpoint of improving the resistance to high wet heat of the pressure-sensitive adhesive composition. When the content is 0.01 parts by mass or more, then the durability of the resultant pressure-sensitive adhesive composition could be fully enhanced. On the other hand, when 1.0 part by mass or less, then the antioxidant could be prevented from precipitating as separated from the other components.

### (UV Absorbent)

The UV absorbent includes, for example, hindered amine-based compounds, benzotriazole-based compounds, oxazoliac acid amide compounds, benzophenone-based compounds, etc. As commercial products, there are mentioned Tinuvin 765 (manufactured by BASS Ltd., hindered amine-based compound), etc.

The content of the UV absorbent, if any, in the pressure-sensitive adhesive composition of the present invention is preferably from 0.01 to 3.0 parts by mass relative to 100 parts by mass of the component (A) (components (A-1) to (A-3)), more preferably from 0.03 to 2.0 parts by mass, even more preferably from 0.04 to 1.0 part by mass.

### (Light Stabilizer)

The light stabilizer includes, for example, hindered amine-based light stabilizer, benzophenone-based light stabilizer, benzotriazole-based light stabilizer, etc.

The content of the light stabilizer, if any, in the pressure-sensitive adhesive composition of the present invention is preferably from 0.01 to 2 parts by mass relative to 100 parts by mass of the component (A) (components (A-1) to (A-3)).

### (Resin Stabilizer)

The resin stabilizer includes, for example, imidazole-based resin stabilizer, dithiocarbamic acid salt-based resin stabilizer, phosphorus-containing resin stabilizer, sulfur ester-based resin stabilizer, etc.

The content of the resin stabilizer, if any, in the pressure-sensitive adhesive composition of the present invention is preferably from 0.01 to 3 parts by mass relative to 100 parts by mass of the component (A) (components (A-1) to (A-3)).

### [Pressure-Sensitive Adhesive Sheet]

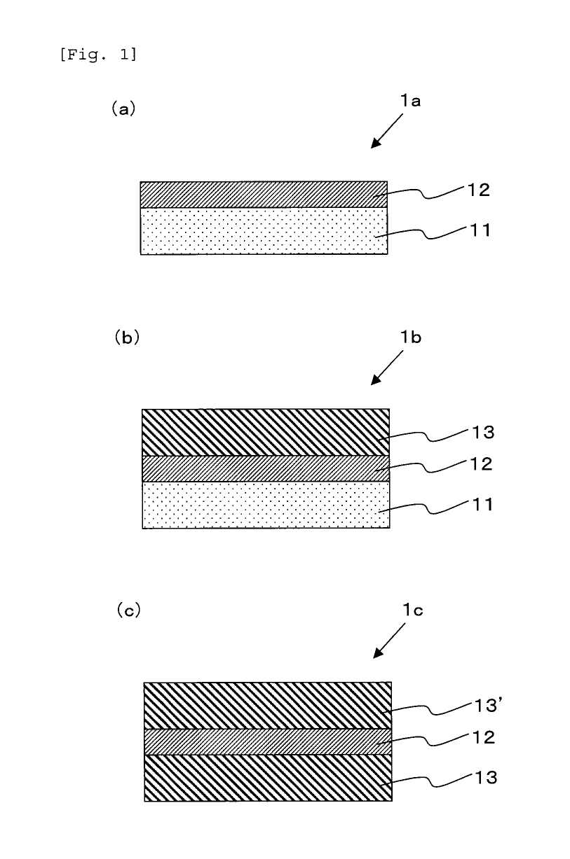

The pressure-sensitive adhesive sheet of the present invention has a pressure-sensitive adhesive layer formed of the above-mentioned pressure-sensitive adhesive composition of the present invention, and is preferably a pressure-sensitive adhesive sheet having the pressure-sensitive adhesive layer on a substrate or on a release material. The configuration of the pressure-sensitive adhesive sheet of the present invention is not specifically defined. The configuration is not limited to the pressure-sensitive adhesive sheet 1a shown in FIG. 1(a), having the pressure-sensitive adhesive layer 12 formed on the substrate 11.

For example, there are mentioned the pressure-sensitive adhesive sheet 1b shown in FIG. 1(b), having the pressure-sensitive adhesive layer 12 formed on the substrate 11 and additionally having another substrate 11′ formed on the layer; the pressure-sensitive adhesive sheet 1c shown in FIG. 1(c), having the pressure-sensitive adhesive layer 12 formed on the substrate 11 and having a peelable release material 13 formed on the layer 12.

The pressure-sensitive adhesive sheet 1d shown in FIG. 1(d) is further mentioned, in which the pressure-sensitive adhesive layer 12 is sandwiched between the peelable release material 13 and another peelable release material 13′ with no substrate therein. In the pressure-sensitive adhesive sheet 1d, the release material 13 and the release material 13′ may be formed of the same type of release material, or each may be formed of a different type of release material. However, it is desirable that the two materials are so selected that the release power could differ between the release material 13 and the release material 13′.

The thickness of the pressure-sensitive adhesive layer of the pressure-sensitive adhesive sheet may be suitably determined depending on the use thereof, but is preferably from 0.5 to 100 μm, more preferably from 1 to 60 μm, even more preferably from 3 to 40 μm. When the thickness of the pressure-sensitive adhesive layer is 0.5 μm or more, then the layer can have a good adhesive strength to adherends. On the other hand, when 100 μm or less, then it is advantageous in point of the productivity, and an easily handleable pressure-sensitive adhesive sheet can be produced.

### (Substrate)

Not specifically defined, the substrate may be suitably selected in accordance with the intended use of the pressure-sensitive adhesive sheet.

The substrate includes, for example, plastic films or plastic sheets formed of resins such as polyolefin resins, e.g., polyethylene resin, polypropylene resin, etc., polyester resins, e.g., polybutylene terephthalate resin, polyethylene terephthalate resin, etc., acetate resins, ABS resins, polystyrene resins, vinyl chloride resins, etc., and their mixtures or laminates, etc.; paper substrates such as high-quality paper, art paper, coated paper, glassine paper, etc.; other various paper substrates such as laminated paper substrates and the like produced by laminating a thermoplastic resin such as polyethylene or the like on the above-mentioned paper substrates; various synthetic paper substrates; metal foils such as aluminium foil, copper foil, iron foil, etc.; porous material substrates such as nonwoven fabric, etc. The plastic films or plastic sheets may be unstretched, or may be stretched monoaxially or biaxially, for example, in the machine direction or in the lateral direction.

The substrate to be used here is not specifically defined in point of the presence or absence of discoloration thereof, but preferred is a substrate that can sufficiently transmit UV rays, and more preferred is a substrate that is colorless and transparent even in a visible light region.

The substrate may further contain a UV absorbent, a light stabilizer, an antioxidant, an antistatic agent, a slip agent, an antiblocking agent, a colorant, etc.

The surface or the back of the substrate may be printed with patterns, letters or the like. For this, the substrate may be provided with a thermal recording layer, a printed image-receiving layer for thermal transfer, inkjet printing, laser printing or the like, a printability improving layer, etc. The pressure-sensitive adhesive sheet that uses an opaque substrate printed with patterns, letters or the like may be used in cases where the printed face is observed via the pressure-sensitive adhesive layer of the pressure-sensitive adhesive sheet.

In case where a plastic material is used as the substrate, it is desirable to optionally process the surface of the substrate for surface treatment according to an oxidation method, a roughening method or the like for the purpose of improving the adhesiveness between the substrate and the pressure-sensitive adhesive layer.

Not specifically defined, the oxidation method includes, for example, a corona discharge treatment method, a plasma treatment method, chromic acid oxidation (wet treatment), flame treatment, hot air treatment, ozone/UV irradiation treatment, etc.

Also not specifically defined, the roughening method includes, for example, a sandblasting method, a solvent treatment method, etc.

These surface treatments may be suitably selected depending on the type of the substrate, but preferred is a corona discharge treatment method from the viewpoint of the effect to improve the adhesiveness to the pressure-sensitive adhesive layer and of the operability. Primer treatment may be given to the substrate.

Also not specifically defined, the thickness of the substrate is generally from 10 to 250 μm but is preferably from 15 to 200 μm, more preferably from 20 to 150 μm from the viewpoint of the handleability thereof.

### (Release Material)

As the release material, there is mentioned one produced by coating a substrate with a release agent, and a release sheet processed for release treatment on both surfaces thereof as well as a release sheet processed for release treatment on one surface thereof may be used here.

The substrate includes, for example, paper substrates such as glassine paper, coated paper, high-quality paper, etc.; laminated paper substrates produced by laminating a thermoplastic resin such as polyethylene or the like on these paper substrates; plastic films such as polyester resin films of polyethylene terephthalate resin, polybutylene terephthalate resin, polyethylene naphthalate resin or the like, polyolefin resin films of polypropylene resin, polyethylene resin or the like, etc.

The release agent includes, for example, rubber-based elastomers such as silicone-based resin, olefine-based resin, isoprene-based resin, butadiene-based resin, etc.; long-chain alkyl-based resins, alkyd-based resins, fluoro-based resins, etc.

Not specifically defined, the thickness of the release material is generally from 20 to 200 μm but is preferably from 25 to 150 μm.

### (Production Method for Pressure-Sensitive Adhesive Sheet)

The production method for the pressure-sensitive adhesive sheet of the present invention is not specifically defined. For example, there is mentioned a method for producing the pressure-sensitive adhesive sheet, which comprises adding an organic solvent such as toluene, ethyl acetate, methyl ethyl ketone or the like to the pressure-sensitive adhesive composition of the present invention to prepare a solution of the pressure-sensitive adhesive composition, then coating the solution onto the surface of the substrate or onto the release-treated surface of the release material according to a known coating method, and thereafter drying it to form a pressure-sensitive adhesive layer thereon, thereby producing the intended pressure-sensitive adhesive sheet.

When the pressure-sensitive adhesive layer formed on a substrate according to the above-mentioned method is stuck to another substrate, then the pressure-sensitive adhesive sheet 1b shown in FIG. 1(b) can be produced. Besides the above, the pressure-sensitive adhesive layer formed on a substrate or a release material according to the above-mentioned method may be stuck to the release-treated surface of the above-mentioned release material to produce the pressure-sensitive adhesive sheet 1c shown in FIG. 1(c) or the pressure-sensitive adhesive sheet 1d shown in FIG. 1(d).

The solid concentration in the solution of the pressure-sensitive adhesive composition is preferably from 10 to 60% by mass, more preferably from 10 to 45% by mass, even more preferably from 15 to 30% by mass. When the solid concentration is 10% by mass or more, then the coatability with the solution is good. On the other hand, when the solid concentration is 60% by mass or less, then the solution of the pressure-sensitive adhesive composition could have a suitable viscosity and could secure excellent coating workability.

The coating method may be any known coating method including, for example, a spin coating method, a spray coating method, a bar coating method, a knife coating method, a roll coating method, a blade coating method, a die coating method, a gravure coating method, etc. After the substrate or the release layer surface of the release material has been coated with the solution of the pressure-sensitive adhesive composition dissolved in an organic solvent, it is desirable that the coating layer is dried by heating at a temperature of from 80 to 150° C. for from 30 seconds to 5 minutes for preventing the solvent and low-boiling point component from remaining in the pressure-sensitive adhesive layer to be formed.

### EXAMPLES

The weight-average molecular weight of the acrylic copolymer used in Examples, Reference Examples and Comparative Examples is a value measured according to the method mentioned below.

### <Method for Measurement of Weight-Average Molecular Weight (Mw)>

Using a gel permeation chromatography apparatus (manufactured by TOSOH CORPORATION, product name “HLC-8020”), the copolymer was analyzed under the condition mentioned below to determine the standard polystyrene-equivalent weight-average molecular weight thereof.

### (Measurement Condition)

Column: “TSK guard column HXL-H”, two “TSK gel GMHXL” and “TSK gel G2000HXL” (all manufactured by TOSOH CORPORATION)
Column temperature: 40° C.
Developing solvent: tetrahydrofuran
Flow rate: 1.0 mL/min

The details of the components used in the following Examples, Reference Examples and Comparative Examples are as follows:

### [Acrylic Copolymer]

“a-1”: acrylic copolymer comprising butyl acrylate (BA) and acrylic acid (AA), BA/AA=99.0/1.0 (% by mass), weight-average molecular weight 290,000, solid concentration 48% by mass.
“a-2”: acrylic copolymer comprising butyl acrylate (BA) and acrylic acid (AA), BA/AA=99.9/0.1 (% by mass), weight-average molecular weight 220,000, solid concentration 47% by mass.
“a-3”: acrylic copolymer comprising butyl acrylate (BA), methyl acrylate (MA) and 4-hydroxybutyl acrylate (4HBA), BA/MA/4HBA=79.0/20.0/1.0 (% by mass), weight-average molecular weight 900,000, solid concentration 30% by mass.
“a-4”: acrylic copolymer comprising butyl acrylate (BA) and 2-hydroxyethyl acrylate (HEA), BA/HEA=70.0/30.0 (% bymass), weight-average molecular weight 900,000, solid concentration 30% by mass.
“a-5”: acrylic copolymer comprising butyl acrylate (BA), isobutyl acrylate (iBA), vinyl acetate (VAc), 2-hydroxyethyl methacrylate (HEMA) and methacrylic acid (MAA), BA/iBA/VAc/HEMA/MAA=44.0/44.0/5.76/6.20/0.04 (% by mass), weight-average molecular weight 800,000, solid concentration 37% by mass.
“a-6”: acrylic copolymer comprising butyl acrylate (BA) and acrylic acid (AA), BA/AA=91.0/9.0 (% by mass), weight-average molecular weight 800,000, solid concentration 34% by mass.
“a-7”: acrylic copolymer comprising butyl acrylate (BA) and acrylic acid (AA), BA/AA=94.0/6.0 (% by mass), weight-average molecular weight 800,000, solid concentration 34% by mass.
“a-8”: acrylic copolymer comprising butyl acrylate (BA) and acrylic acid (AA), BA/AA=96.0/4.0 (% by mass), weight-average molecular weight 1,450,000, solid concentration 17% by mass.
“a-9”: acrylic copolymer comprising butyl acrylate (BA), ethyl acrylate (EA), vinyl acetate (VAc) and acrylamide (AAm), BA/EA/VAc/AAm=54.0/27.0/17.0/2.0 (% by mass), weight-average molecular weight 1,000,000, solid concentration 24.6% by mass.

### [Crosslinking Agent]

“Coronate L”: product name, manufactured by Nippon Polyurethane Industry Co., Ltd., tolylene diisocyanate-based crosslinking agent, solid concentration 75% by mass.
“TD-75”: product name, manufactured by Soken Chemical & Engineering Co., Ltd., xylene diisocyanate-based crosslinking agent, solid concentration 30% by mass.
“Coronate HL”: product name, manufactured by Nippon Polyurethane Industry Co., Ltd., hexamethylene diisocyanate-based crosslinking agent, solid concentration 75% by mass.

### <Photochromic Dye>

“c-1 (B2287)”: dithienylethene-based compound represented by the following formula (1) (manufactured by Tokyo Chemical Industry Co., Ltd., product name “B2287”).

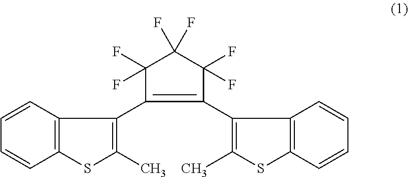 [SMILES: Cc1sc2ccccc2c1C1=C(c2c(C)sc3ccccc23)C(F)(F)C(F)(F)C1(F)F]

“c-2 (T1259)”: oxazine-based compound represented by the following formula (2) (manufactured by Tokyo Chemical Industry Co., Ltd., product name “T1259”).

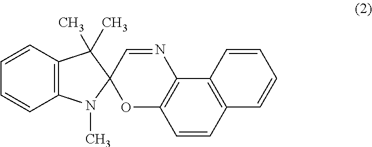 [SMILES: CN1c2ccccc2C(C)(C)C12C=Nc1c(ccc3ccccc13)O2]

“c-3 (D3197)”: naphthopyran-based compound represented by the following formula (3) (manufactured by Tokyo Chemical Industry Co., Ltd., product name “D3197”).

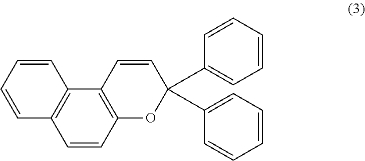 [SMILES: C1=CC(c2ccccc2)(c2ccccc2)Oc2ccc3ccccc3c21]

“c-4 (T0366)”: spiropyran-based compound represented by the following formula (4) (manufactured by Tokyo Chemical Industry Co., Ltd., product name “T0366”).

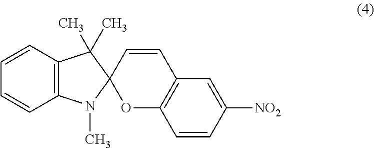 [SMILES: CN1c2ccccc2C(C)(C)C12C=Cc1cc([N+](=O)[O-])ccc1O2]

### Examples 1a to 10a, Reference Examples 1a to 8a, Comparative Examples 1a to 4a

To 100 parts by mass, in terms of the solid content thereof, of the acrylic copolymer shown in Table 1, added were the crosslinking agent and the photochromic dye each in the amount (as solid ratio) shown in Table 1. These were mixed and then diluted with methyl ethyl ketone to prepare a solution of a pressure-sensitive adhesive composition having a solid concentration of 25% by mass.

Onto a polyethylene terephthalate (PET) film (manufactured by Toray Industries, Inc., product name “Lumirror”) serving as a substrate and having a thickness of 100 μm, the above-mentioned solution of pressure-sensitive adhesive composition was coated in such a manner that the thickness of the pressure-sensitive adhesive layer formed after drying could be 20 μm, and then heated at 120° C. for 2 minutes to form thereon a pressure-sensitive adhesive layer having a thickness of 20 μm. Next, the release-treated surface of a release-treated polyethylene terephthalate film (manufactured by LINTEC Corporation, product name “SP-PET380101”) serving as a release sheet (release material) was stuck to the surface of the pressure-sensitive adhesive layer to produce a pressure-sensitive adhesive sheet.

The produced pressure-sensitive adhesive sheet was cut into a size of 20 mm×20 mm, the release sheet was removed, and the exposed adhesive surface was stuck to a glass plate (manufactured by NSG PRECISION Co., Ltd., product name “Corning Glass Eagle XG”, 150 mm×70 mm×2 mm) using a squeegee to prepare samples for evaluation.

The sample for evaluation was evaluated for the characteristics of the pressure-sensitive adhesive sheet according to the methods mentioned below. The results are shown in Table 1.

### (1-a) Evaluation for Presence or Absence of Discoloration in UV Rays-Free Environments

First, in a UV rays-free environment, the above sample for evaluation was observed visually, and evaluated for the presence or absence of discoloration thereof according to the criteria mentioned below. (This evaluation result is given in the column of “immediately after production” in Table 1.)

Further, using a weather resistance tester (manufactured by Suga Test Instruments Co., Ltd., product name “UV Fadeometer U48”, light source: UV carbon arc lamp) (hereinafter this may be referred to as “FOM”), the sample for evaluation was exposed to FOM for 75 hours and 150 hours.

Next, in a UV rays-free environment, the sample for evaluation having been exposed to the lamp for the period of time mentioned above was observed visually, and evaluated for the presence or absence of discoloration thereof according to the criteria mentioned below. (The evaluation results are given in the columns of “FOM 75 h” and “FOM 150 h” in Table 1).

### <Evaluation Criteria for Presence or Absence of Discoloration in UV Rays-Free Environments>

A+: No discoloration was recognized, and the sample was colorless.

A: Slight discoloration was recognized in looking steadily, but the sample was nearly colorless.

B: Pale discoloration in pale yellow, pale red, pale brown or the like was recognized.

C: Clear discoloration in yellow, red, brown or the like was recognized.

### (2-a) Evaluation of Photochromic Performance

The produced sample for evaluation was irradiated with UV ray (wavelength 365 nm) for 5 seconds, using a UV irradiation device (manufactured by AS ONE Corporation, product name “Handy UV Lamp SLUV-4”), and the thus-irradiated sample for evaluation was visually checked for the photochromic performance thereof according to the criteria mentioned below. (The evaluation result is given in the column of “immediately after production” in Table 1.)

Further, using a weather resistance tester (manufactured by Suga Test Instruments Co., Ltd., product name “UV Fadeometer U48”, light source: UV carbon arc lamp) (hereinafter this may be referred to as “FOM”), the sample for evaluation was exposed to FOM for 25 hours, 50 hours, 75 hours, 100 hours and 150 hours.

Next, the sample for evaluation having been exposed to the lamp for the period of time mentioned above was irradiated with UV ray (wavelength 365 nm) for 5 seconds, and the thus-irradiated sample for evaluation was visually checked for the photochromic performance thereof according to the criteria mentioned below. (The evaluation results are given in the columns of “FOM 25 h” to “FOM 150 h” in Table 1.)

### <Evaluation Criteria for Photochromic Performance>

A: Fully colored.

B: Colored but weakly.

C: Not colored (no change).

### (3-a) Evaluation of Time for Restoration to Colorless

The produced sample for evaluation was irradiated with UV ray (wavelength 365 nm) for 5 seconds, using a UV irradiation device (manufactured by AS ONE Corporation, product name “Handy UV Lamp SLUV-4”), and the time taken to restore the thus-irradiated sample for evaluation to the state before irradiation with UV rays was measured, to thereby evaluate the time for restoration to colorless taken by the sample according to the criteria mentioned below for the measured time.

### <Evaluation Criteria for Time for Restoration to Colorless>

A: Restored to colorless in shorter than 20 minutes.

F: Not restored to colorless in 20 minutes or more.

TABLE 1

| | Formulation of Pressure-Sensitive Adhesive Composition | | | | | | |
|---|---|---|---|---|---|---|---|
| | Acrylic Copolymer | | | | Crosslinking Agent | | |
| | | | Content of Carboxyl | | | Amount | Photochromic |
| | Type of | Compositional Ratio | Group or Primary Amino | Amount (part | Type of | (part | Dye |
| | Copolymer | (mass %) | Group (mass %) | by mass*¹) | Agent | by mass*¹) | Type of Dye |
| Example 1a | a-1 | BA/AA = 99.0/1.0 | 1.0 | 100 | Coronate L | 2.21 | c-1 |
| | | | | | | | (B2287) |
| Example 2a | a-1 | BA/AA = 99.0/1.0 | 1.0 | 100 | Coronate L | 2.21 | c-1 |
| | | | | | | | (B2287) |
| Example 3a | a-2 | BA/AA = 99.9/0.1 | 0.1 | 100 | Coronate L | 2.21 | c-1 |
| | | | | | | | (B2287) |
| Example 4a | a-2 | BA/AA = 99.9/0.1 | 0.1 | 100 | Coronate L | 2.21 | c-1 |
| | | | | | | | (B2287) |
| Example 5a | a-3 | BA/MA/4HBA = 79.0/20.0/1.0 | 0.0 | 100 | TD-75 | 0.13 | c-1 |
| | | | | | | | (B2287) |
| Example 6a | a-3 | BA/MA/4HBA = 79.0/20.0/1.0 | 0.0 | 100 | TD-75 | 0.13 | c-1 |
| | | | | | | | (B2287) |
| Example 7a | a-4 | BA/HEA = 70.0/30.0 | 0.0 | 100 | Coronate L | 4.25 | c-1 |
| | | | | | | | (B2287) |
| Example 8a | a-4 | BA/HEA = 70.0/30.0 | 0.0 | 100 | Coronate L | 4.25 | c-1 |
| | | | | | | | (B2287) |
| Example 9a | a-5 | BA/iBA/VAc/HEMA/MAA = | 0.04 | 100 | Coronate HL | 0.39 | c-1 |
| | | 44.0/44.0/5.76/6.20/0.04 | | | | | (B2287) |
| Example 10a | a-5 | BA/iBA/VAc/HEMA/MAA = | 0.04 | 100 | Coronate HL | 0.39 | c-1 |
| | | 44.0/44.0/5.76/6.20/0.04 | | | | | (B2287) |
| Reference | a-6 | BA/AA = 91.0/9.0 | 9.0 | 100 | Coronate L | 2.21 | c-1 |
| Example 1a | | | | | | | (B2287) |
| Reference | a-6 | BA/AA = 91.0/9.0 | 9.0 | 100 | Coronate L | 2.21 | c-1 |
| Example 2a | | | | | | | (B2287) |
| Reference | a-7 | BA/AA = 94.0/6.0 | 6.0 | 100 | Coronate L | 2.21 | c-1 |
| Example 3a | | | | | | | (B2287) |
| Reference | a-7 | BA/AA = 94.0/6.0 | 6.0 | 100 | Coronate L | 2.21 | c-1 |
| Example 4a | | | | | | | (B2287) |
| Reference | a-8 | BA/AA = 96.0/4.0 | 4.0 | 100 | Coronate L | 2.21 | c-1 |
| Example 5a | | | | | | | (B2287) |
| Reference | a-8 | BA/AA = 96.0/4.0 | 4.0 | 100 | Coronate L | 2.21 | c-1 |
| Example 6a | | | | | | | (B2287) |
| Reference | a-9 | BA/EA/VAc/AAm = | 2.0 | 100 | Coronate L | 3.05 | c-1 |
| Example 7a | | 54.0/27.0/17.0/2.0 | | | | | (B2287) |
| Reference | a-9 | BA/EA/VAc/AAm = | 2.0 | 100 | Coronate L | 3.05 | c-1 |
| Example 8a | | 54.0/27.0/17.0/2.0 | | | | | (B2287) |
| Comparative | a-5 | BA/iBA/VAc/HEMA/MAA = | 0.04 | 100 | Coronate HL | 0.39 | c-4 |
| Example 1a | | 44.0/44.0/5.76/6.20/0.04 | | | | | (T0366) |
| Comparative | a-5 | BA/iBA/VAc/HEMA/MAA = | 0.04 | 100 | Coronate HL | 0.39 | c-4 |
| Example 2a | | 44.0/44.0/5.76/6.20/0.04 | | | | | (T0366) |
| Comparative | a-9 | BA/EA/VAc/AAm = | 2.0 | 100 | Coronate L | 3.05 | c-4 |
| Example 3a | | 54.0/27.0/17.0/2.0 | | | | | (T0366) |
| Comparative | a-9 | BA/EA/VAc/AAm = | 2.0 | 100 | Coronate L | 3.05 | c-4 |
| Example 4a | | 54.0/27.0/17.0/2.0 | | | | | (T0366) |

| | Formulation of | Evaluation Items | | | | | | | | | |
|---|---|---|---|---|---|---|---|---|---|---|---|
| | Pressure-Sensitive | Presence or Absence of | | | | | | | | | |
| | Adhesive Composition | Discoloration in UV Rays-Free | | | | | | | | | |
| | Photochromic Dye | Environments | | | Photochromic Performance | | | | | | Time Taken |
| | Amount (part | immediately | FOM | FOM | immediately | FOM | FOM | FOM | FOM | FOM | for Restration |
| | by mass*¹) | after production | 75 h | 150 h | after production | 25 h | 50 h | 75 h | 100 h | 150 h | to Colorless |
| Example 1a | 0.96 | A+ | A | A | A | A | A | A | A | B | A |
| Example 2a | 2.88 | A+ | A | B | A | A | A | A | A | A | A |
| Example 3a | 0.96 | A+ | A | A | A | A | A | A | A | B | A |
| Example 4a | 2.88 | A+ | A | B | A | A | A | A | A | A | A |
| Example 5a | 0.96 | A+ | A+ | A | A | A | A | A | A | A | A |
| Example 6a | 2.88 | A+ | A+ | A | A | A | A | A | A | A | A |
| Example 7a | 0.96 | A+ | A+ | A | A | A | A | A | A | A | A |
| Example 8a | 2.88 | A+ | B | B | A | A | A | A | A | A | A |
| Example 9a | 0.96 | A+ | A+ | A+ | A | A | A | A | A | A | A |
| Example 10a | 2.88 | A+ | A+ | A+ | A | A | A | A | A | A | A |
| Reference | 0.96 | A | B | B | A | A | C | C | C | C | A |
| Example 1a | | | | | | | | | | | |
| Reference | 2.88 | A | B | C | A | A | C | C | C | C | A |
| Example 2a | | | | | | | | | | | |
| Reference | 0.96 | A+ | A | A | A | A | A | C | C | C | A |
| Example 3a | | | | | | | | | | | |
| Reference | 2.88 | A+ | A | B | A | A | A | A | A | C | A |
| Example 4a | | | | | | | | | | | |
| Reference | 0.96 | A+ | A | A | A | A | A | C | C | C | A |
| Example 5a | | | | | | | | | | | |
| Reference | 2.88 | A+ | A | B | A | A | A | A | A | C | A |
| Example 6a | | | | | | | | | | | |
| Reference | 0.96 | A+ | B | C | A | C | C | C | C | C | A |
| Example 7a | | | | | | | | | | | |
| Reference | 2.88 | A+ | C | C | A | C | C | C | C | C | A |
| Example 8a | | | | | | | | | | | |
| Comparative | 0.96 | B | B | B | A | C | C | C | C | C | F |
| Example 1a | | | | | | | | | | | |
| Comparative | 2.88 | B | C | C | A | C | C | C | C | C | F |
| Example 2a | | | | | | | | | | | |
| Comparative | 0.96 | B | B | B | A | C | C | C | C | C | F |
| Example 3a | | | | | | | | | | | |
| Comparative | 2.88 | B | C | C | A | C | C | C | C | C | F |
| Example 4a | | | | | | | | | | | |

*¹Solid ratio relative to 100 parts by mass of the solid content of the acrylic copolymer.

It is known that the pressure-sensitive adhesive sheets of Examples 1a to 10a and Reference Examples 1a to 8a are colorless before irradiation with UV rays and they take a short time for restoration to colorless and have a relative rapid rate of color change from colored to colorless. On the other hand, the pressure-sensitive adhesive sheets of Comparative Examples 1a to 4a were recognized to be already colored before irradiation with UV rays, and take a long time for restoration to colorless.

In addition, the pressure-sensitive adhesive sheets of Examples 1a to 10a were still prevented from being discolored even after exposed to FOM for 150 hours, and the results thereof are that the adhesive sheets can prevent them from being kept discolored all the time even in UV rays-free environments. Further, even after exposed to FOM for 150 hours, the pressure-sensitive adhesive sheets of these Examples were confirmed to be colored through UV irradiation and to keep photochromic performance, and it is known that the sheets have excellent weather resistance.

### Examples 1b to 12b, Reference Examples 1b to 6b, Comparative Examples 1b to 4b

To 100 parts by mass, in terms of the solid content thereof, of the acrylic copolymer shown in Table 2, added were the crosslinking agent and the photochromic dye each in the amount (as solid ratio) shown in Table 2. These were mixed and then diluted with methyl ethyl ketone to prepare a solution of a pressure-sensitive adhesive composition having a solid concentration of 25% by mass.

Using the resultant solution of pressure-sensitive adhesive composition, a pressure-sensitive adhesive sheet was produced in the same manner as in the above-mentioned Example 1a and others, thereby preparing samples for evaluation.

The sample for evaluation was evaluated for the characteristics of the pressure-sensitive adhesive sheet according to the methods mentioned below. The results are shown in Table 2.

### (1-b) Evaluation for Presence or Absence of Discoloration in UV Rays-Free Environments

First, in a UV rays-free environment, the above sample for evaluation was observed visually, and evaluated for the presence or absence of discoloration thereof according to the criteria mentioned below. (This evaluation result is given in the column of “immediately after production” in Table 2.)

Further, using a weather resistance tester (manufactured by Suga Test Instruments Co., Ltd., product name “UV Fadeometer U48”, light source: UV carbon arc lamp) (hereinafter this may be referred to as “FOM”), the sample for evaluation was exposed to FOM for 75 hours and 150 hours.

Next, in a UV rays-free environment, the sample for evaluation having been exposed to the lamp for the period of time mentioned above was observed visually, and evaluated for the presence or absence of discoloration thereof according to the criteria mentioned below. (The evaluation results are given in the columns of “FOM 75 h” and “FOM 150 h” in Table 2).

### <Evaluation Criteria for Presence or Absence of Discoloration in UV Rays-Free Environments>

A+: No discoloration was recognized, and the sample was colorless.

A: Slight discoloration was recognized in looking steadily, but the sample was nearly colorless.

B: Pale discoloration in pale yellow, pale red, pale brown or the like was recognized.

C: Clear discoloration in yellow, red, brown or the like was recognized.

### (2-b) Evaluation of Photochromic Performance

The produced sample for evaluation was irradiated with UV ray (wavelength 365 nm) for 5 seconds, using a UV irradiation device (manufactured by AS ONE Corporation, product name “Handy UV Lamp SLUV-4”), and the thus-irradiated sample for evaluation was visually checked for the photochromic performance thereof according to the criteria mentioned below. (The evaluation result is given in the column of “immediately after production” in Table 2.)

Further, using a weather resistance tester (manufactured by Suga Test Instruments Co., Ltd., product name “UV Fadeometer U48”, light source: UV carbon arc lamp) (hereinafter this may be referred to as “FOM”), the sample for evaluation was exposed to FOM for 25 hours and 50 hours.

Next, the sample for evaluation having been exposed to the lamp for the period of time mentioned above was irradiated with UV ray (wavelength 365 nm) for 5 seconds, and the thus-irradiated sample for evaluation was visually checked for the photochromic performance thereof according to the criteria mentioned below. (The evaluation results are given in the columns of “FOM 25 h” and “FOM 50 h” in Table 2.)

### (Evaluation Criteria for Long-Term Weather Resistance)

A: Fully colored.

B: Colored but weakly.

C: Not colored (no change).

### (3-b) Evaluation of Time for Restoration to Colorless

The produced sample for evaluation was irradiated with UV ray (wavelength 365 nm) for 5 seconds, using a UV irradiation device (manufactured by AS ONE Corporation, product name “Handy UV Lamp SLUV-4”), and the time taken to restore the thus-irradiated sample for evaluation to the state before irradiation with UV rays was measured, to thereby evaluate the time for restoration to colorless taken by the sample according to the criteria mentioned below for the measured time.

### <Evaluation Criteria for Time for Restoration to Colorless>

A: Restored to colorless in shorter than 10 seconds.

F: Not restored to colorless in 10 seconds or more.

TABLE 2

| | Formulation of Pressure-Sensitive Adhesive Composition | | | | | |
|---|---|---|---|---|---|---|
| | Acrylic Copolymer | | | | | |
| | | | Content of Carboxyl | | Crosslinking Agent | |
| | Type of | Compositional Ratio | Group or Primary | Amount (part | | Amount (part |
| | Copolymer | (mass %) | Amino Group (mass %) | by mass*¹) | Type of Agent | by mass*¹) |
| Example 1b | a-1 | BA/AA = 99.0/1.0 | 1.0 | 100 | Coronate L | 2.21 |
| Example 2b | a-1 | BA/AA = 99.0/1.0 | 1.0 | 100 | Coronate L | 2.21 |
| Example 3b | a-2 | BA/AA = 99.9/0.1 | 0.1 | 100 | Coronate L | 2.21 |
| Example 4b | a-2 | BA/AA = 99.9/0.1 | 0.1 | 100 | Coronate L | 2.21 |
| Example 5b | a-3 | BA/MA/4HBA = 79.0/20.0/1.0 | 0.0 | 100 | TD-75 | 0.13 |
| Example 6b | a-3 | BA/MA/4HBA = 79.0/20.0/1.0 | 0.0 | 100 | TD-75 | 0.13 |
| Example 7b | a-4 | BA/HEA = 70.0/30.0 | 0.0 | 100 | Coronate L | 4.25 |
| Example 8b | a-4 | BA/HEA = 70.0/30.0 | 0.0 | 100 | Coronate L | 4.25 |
| Example 9b | a-5 | BA/iBA/VAc/HEMA/MAA = | 0.04 | 100 | Coronate HL | 0.39 |
| | | 44.0/44.0/5.76/6.20/0.04 | | | | |
| Example 10b | a-5 | BA/iBA/VAc/HEMA/MAA = | 0.04 | 100 | Coronate HL | 0.39 |
| | | 44.0/44.0/5.76/6.20/0.04 | | | | |
| Example 11b | a-9 | BA/EA/VAc/AAm = | 2.0 | 100 | Coronate L | 3.05 |
| | | 54.0/27.0/17.0/2.0 | | | | |
| Example 12b | a-9 | BA/EA/VAc/AAm = | 2.0 | 100 | Coronate L | 3.05 |
| | | 54.0/27.0/17.0/2.0 | | | | |
| Reference | a-6 | BA/AA = 91.0/9.0 | 9.0 | 100 | Coronate L | 2.21 |
| Example 1b | | | | | | |
| Reference | a-6 | BA/AA = 91.0/9.0 | 9.0 | 100 | Coronate L | 2.21 |
| Example 2b | | | | | | |
| Reference | a-7 | BA/AA = 94.0/6.0 | 6.0 | 100 | Coronate L | 2.21 |
| Example 3b | | | | | | |
| Reference | a-7 | BA/AA = 94.0/6.0 | 6.0 | 100 | Coronate L | 2.21 |
| Example 4b | | | | | | |
| Reference | a-8 | BA/AA = 96.0/4.0 | 4.0 | 100 | Coronate L | 2.21 |
| Example 5b | | | | | | |
| Reference | a-8 | BA/AA = 96.0/4.0 | 4.0 | 100 | Coronate L | 2.21 |
| Example 6b | | | | | | |
| Comparative | a-5 | BA/iBA/VAc/HEMA/MAA = | 0.04 | 100 | Coronate HL | 0.39 |
| Example 1b | | 44.0/44.0/5.76/6.20/0.04 | | | | |
| Comparative | a-5 | BA/iBA/VAc/HEMA/MAA = | 0.04 | 100 | Coronate HL | 0.39 |
| Example 2b | | 44.0/44.0/5.76/6.20/0.04 | | | | |
| Comparative | a-9 | BA/EA/VAc/AAm = | 2.0 | 100 | Coronate L | 3.05 |
| Example 3b | | 54.0/27.0/17.0/2.0 | | | | |
| Comparative | a-9 | BA/EA/VAc/AAm = | 2.0 | 100 | Coronate L | 3.05 |
| Example 4b | | 54.0/27.0/17.0/2.0 | | | | |

| | | | Evaluation Items | | | | | | |
|---|---|---|---|---|---|---|---|---|---|
| | Formulation of | | Presence or Absence | | | | | | |
| | Pressure-Sensitive | | of Discoloration in UV | | | | | | |
| | Adhesive Composition | | Rays-Free Environments | | | Photochromic Performance | | | |
| | Photochromic Dye | | immediately | | | immediately | | | Time Taken for |
| | Type of | Amount (part | after | FOM | FOM | after | FOM | FOM | Restration to |
| | Dye | by mass*¹) | production | 75 h | 150 h | production | 25 h | 50 h | Colorless |
| Example 1b | c-2 | 0.96 | A+ | A+ | A | A | A | B | A |
| | (T1259) | | | | | | | | |
| Example 2b | c-2 | 2.88 | A+ | A | B | A | A | A | A |
| | (T1259) | | | | | | | | |
| Example 3b | c-2 | 0.96 | A+ | A+ | A | A | A | B | A |
| | (T1259) | | | | | | | | |
| Example 4b | c-2 | 2.88 | A+ | A | B | A | A | A | A |
| | (T1259) | | | | | | | | |
| Example 5b | c-2 | 0.96 | A+ | A | A | A | A | A | A |
| | (T1259) | | | | | | | | |
| Example 6b | c-2 | 2.88 | A+ | A | B | A | A | A | A |
| | (T1259) | | | | | | | | |
| Example 7b | c-2 | 0.96 | A+ | A | A | A | A | A | A |
| | (T1259) | | | | | | | | |
| Example 8b | c-2 | 2.88 | A+ | B | B | A | A | A | A |
| | (T1259) | | | | | | | | |
| Example 9b | c-2 | 0.96 | A+ | A | A | A | A | A | A |
| | (T1259) | | | | | | | | |
| Example 10b | c-2 | 2.88 | A+ | A | B | A | A | A | A |
| | (T1259) | | | | | | | | |
| Example 11b | c-2 | 0.96 | A+ | A+ | B | A | A | A | A |
| | (T1259) | | | | | | | | |
| Example 12b | c-2 | 2.88 | A+ | B | C | A | A | A | A |
| | (T1259) | | | | | | | | |
| Reference | c-2 | 0.96 | A | A | A | A | C | C | A |
| Example 1b | (T1259) | | | | | | | | |
| Reference | c-2 | 2.88 | A | A | A | A | C | C | A |
| Example 2b | (T1259) | | | | | | | | |
| Reference | c-2 | 0.96 | A+ | A | A | A | A | C | A |
| Example 3b | (T1259) | | | | | | | | |
| Reference | c-2 | 2.88 | A+ | A | A | A | A | C | A |
| Example 4b | (T1259) | | | | | | | | |
| Reference | c-2 | 0.96 | A+ | A | A | A | A | C | A |
| Example 5b | (T1259) | | | | | | | | |
| Reference | c-2 | 2.88 | A+ | A | A | A | A | C | A |
| Example 6b | (T1259) | | | | | | | | |
| Comparative | c-4 | 0.96 | B | B | B | A | C | C | F |
| Example 1b | (T0366) | | | | | | | | |
| Comparative | c-4 | 2.88 | B | C | C | A | C | C | F |
| Example 2b | (T0366) | | | | | | | | |
| Comparative | c-4 | 0.96 | B | B | B | A | C | C | F |
| Example 3b | (T0366) | | | | | | | | |
| Comparative | c-4 | 2.88 | B | C | C | A | C | C | F |
| Example 4b | (T0366) | | | | | | | | |

(*1): Solid ratio relative to 100 parts by mass of the solid content of the acrylic copolymer.

It is known that the pressure-sensitive adhesive sheets of Examples 1b to 12b and Reference Examples 1b to 6b are colorless before irradiation with UV rays and they take a short time for restoration to colorless and have a relative rapid rate of color change from colored to colorless. On the other hand, the pressure-sensitive adhesive sheets of Comparative Examples 1b to 4b were recognized to be already colored before irradiation with UV rays, and take a long time for restoration to colorless.

In addition, the pressure-sensitive adhesive sheets of Examples 1b to 12b were still prevented from being discolored even after exposed to FOM for 75 hours, and the results thereof are that the adhesive sheets can prevent them from being kept discolored all the time even in UV rays-free environments. Further, even after exposed to FOM for 50 hours, the pressure-sensitive adhesive sheets of these Examples were confirmed to be colored through UV irradiation and to keep photochromic performance, and it is known that the sheets have excellent weather resistance.

### Examples 1c to 6c, Reference Examples 1c to 10c, Comparative Examples 1c to 4c

To 100 parts by mass, in terms of the solid content thereof, of the acrylic copolymer shown in Table 3, added were the crosslinking agent and the photochromic dye each in the amount (as solid ratio) shown in Table 3. These were mixed and then diluted with methyl ethyl ketone to prepare a solution of a pressure-sensitive adhesive composition having a solid concentration of 25% by mass.

Using the resultant solution of pressure-sensitive adhesive composition, a pressure-sensitive adhesive sheet was produced in the same manner as in the above-mentioned Example 1a and others, thereby preparing samples for evaluation.

The sample for evaluation was evaluated for the characteristics of the pressure-sensitive adhesive sheet according to the methods mentioned below. The results are shown in Table 3.

### (1-c) Evaluation for Presence or Absence of Discoloration in UV Rays-Free Environments

First, in a UV rays-free environment, the above sample for evaluation was observed visually, and evaluated for the presence or absence of discoloration thereof according to the criteria mentioned below. (This evaluation result is given in the column of “immediately after production” in Table 3.)

Further, using a weather resistance tester (manufactured by Suga Test Instruments Co., Ltd., product name “UV Fadeometer U48”, light source: UV carbon arc lamp) (hereinafter this may be referred to as “FOM”), the sample for evaluation was exposed to FOM for 75 hours and 150 hours.

Next, in a UV rays-free environment, the sample for evaluation having been exposed to the lamp for the period of time mentioned above was observed visually, and evaluated for the presence or absence of discoloration thereof according to the criteria mentioned below. (The evaluation results are given in the columns of “FOM 75 h” and “FOM 150 h” in Table 3).

### <Evaluation Criteria for Presence or Absence of Discoloration in UV Rays-Free Environments>

A+: No discoloration was recognized, and the sample was colorless.

A: Slight discoloration was recognized in looking steadily, but the sample was nearly colorless.

B: Pale discoloration in pale yellow, pale red, pale brown or the like was recognized.

C: Clear discoloration in yellow, red, brown or the like was recognized.

### (2-c) Evaluation of Photochromic Performance

The produced sample for evaluation was irradiated with UV ray (wavelength 365 nm) for 5 seconds, using a UV irradiation device (manufactured by AS ONE Corporation, product name “Handy UV Lamp SLUV-4”), and the thus-irradiated sample for evaluation was visually checked for the photochromic performance thereof according to the criteria mentioned below. (The evaluation result is given in the column of “immediately after production” in Table 3.)

Further, using a weather resistance tester (manufactured by Suga Test Instruments Co., Ltd., product name “UV Fadeometer U48”, light source: UV carbon arc lamp) (hereinafter this may be referred to as “FOM”), the sample for evaluation was exposed to FOM for 25 hours and 50 hours.

Next, the sample for evaluation having been exposed to the lamp for the period of time mentioned above was irradiated with UV ray (wavelength 365 nm) for 5 seconds, and the thus-irradiated sample for evaluation was visually checked for the photochromic performance thereof according to the criteria mentioned below. (The evaluation results are given in the columns of “FOM 25 h” and “FOM 50 h” in Table 2.)

### <Evaluation Criteria for Photochromic Performance>

A: Fully colored.

B: Colored but weakly.

C: Not colored (no change).

### (3-c) Evaluation of Time for Restoration to Colorless

The sample for evaluation produced in the manner as above was irradiated with UV ray (wavelength 365 nm) for 5 seconds, using a UV irradiation device (manufactured by AS ONE Corporation, product name “Handy UV Lamp SLUV-4”), and the time taken to restore the thus-irradiated sample for evaluation to the state before irradiation with UV rays was measured, to thereby evaluate the time for restoration to colorless taken by the sample according to the criteria mentioned below.

### <Evaluation Criteria for Time for Restoration to Colorless>

A: Restored to colorless in shorter than 30 seconds.

F: Not restored to colorless in 30 seconds or more.

TABLE 3

| | Formulation of Pressure-Sensitive Adhesive Composition | | | | | | |
|---|---|---|---|---|---|---|---|
| | Acrylic Copolymer | | | | | Crosslinking Agent | |
| | | | Content of Carboxyl | Content of | Amount | | Amount |
| | Type of | Compositional Ratio | Group or Primary | Monomer | (part by | | (part by |
| | Copolymer | (mass %) | Amino Group (mass %) | (a2) (mass %) | mass*¹) | Type of Agent | mass*¹) |
| Example 1c | a-7 | BA/AA = 94.0/6.0 | 6.0 | 6.0 | 100 | Coronate L | 2.21 |
| Example 2c | a-8 | BA/AA = 96.0/4.0 | 4.0 | 4.0 | 100 | Coronate L | 2.21 |
| Example 3c | a-1 | BA/AA = 99.0/1.0 | 1.0 | 1.0 | 100 | Coronate L | 2.21 |
| Example 4c | a-3 | BA/MA/4HBA = 79.0/20.0/1.0 | 0.0 | 1.0 | 100 | TD-75 | 0.13 |
| Example 5c | a-4 | BA/HEA = 70.0/30.0 | 0.0 | 30.0 | 100 | Coronate L | 4.25 |
| Example 6c | a-5 | BA/iBA/VAc/HEMA/MAA = | 0.04 | 6.24 | 100 | Coronate HL | 0.39 |
| | | 44.0/44.0/5.76/6.20/0.04 | | | | | |
| Reference | a-7 | BA/AA = 94.0/6.0 | 6.0 | 6.0 | 100 | Coronate L | 2.21 |
| Example 1c | | | | | | | |
| Reference | a-8 | BA/AA = 96.0/4.0 | 4.0 | 4.0 | 100 | Coronate L | 2.21 |
| Example 2c | | | | | | | |
| Reference | a-1 | BA/AA = 99.0/1.0 | 1.0 | 1.0 | 100 | Coronate L | 2.21 |
| Example 3c | | | | | | | |
| Reference | a-4 | BA/HEA = 70.0/30.0 | 0.0 | 30.0 | 100 | Coronate L | 4.25 |
| Example 4c | | | | | | | |
| Reference | a-5 | BA/iBA/VAc/HEMA/MAA = | 0.04 | 6.24 | 100 | Coronate HL | 0.39 |
| Example 5c | | 44.0/44.0/5.76/6.20/0.04 | | | | | |
| Reference | a-6 | BA/AA = 91.0/9.0 | 9.0 | 9.0 | 100 | Coronate L | 2.21 |
| Example 6c | | | | | | | |
| Reference | a-2 | BA/AA = 99.9/0.1 | 0.1 | 0.1 | 100 | Coronate L | 2.21 |
| Example 7c | | | | | | | |
| Reference | a-2 | BA/AA = 99.9/0.1 | 0.1 | 0.1 | 100 | Coronate L | 2.21 |
| Example 8c | | | | | | | |
| Reference | a-9 | BA/EA/VAc/AAm = | 2.0 | 2.0 | 100 | Coronate L | 3.05 |
| Example 9c | | 54.0/27.0/17.0/2.0 | | | | | |
| Reference | a-9 | BA/EA/VAc/AAm = | 2.0 | 2.0 | 100 | Coronate L | 3.05 |
| Example 10c | | 54.0/27.0/17.0/2.0 | | | | | |
| Comparative | a-5 | BA/iBA/VAc/HEMA/MAA = | 0.04 | 6.24 | 100 | Coronate HL | 0.39 |
| Example 1c | | 44.0/44.0/5.76/6.20/0.04 | | | | | |
| Comparative | a-5 | BA/iBA/VAc/HEMA/MAA = | 0.04 | 6.24 | 100 | Coronate HL | 0.39 |
| Example 2c | | 44.0/44.0/5.76/6.20/0.04 | | | | | |
| Comparative | a-9 | BA/EA/VAc/AAm = | 2.0 | 2.0 | 100 | Coronate L | 3.05 |
| Example 3c | | 54.0/27.0/17.0/2.0 | | | | | |
| Comparative | a-9 | BA/EA/VAc/AAm = | 2.0 | 2.0 | 100 | Coronate L | 3.05 |
| Example 4c | | 54.0/27.0/17.0/2.0 | | | | | |

| | Formulation of | | | | | | | | |
|---|---|---|---|---|---|---|---|---|---|
| | Pressure-Sensitive Evaluation Items | | | | | | | | |
| | Adhesive Composition | | Presence or Absence of | | | | | | |
| | Photochromic Dye | | Discoloration in UV | | | Photochromic Performance | | | |
| | | Amount | Rays-Free Environments | | | immediately | | | Time Taken |
| | | (part by | immediately | FOM | FOM | after | FOM | FOM | for Restration |
| | Type of Dye | mass*¹) | after production | 75 h | 150 h | production | 25 h | 50 h | to Colorless |
| Example 1c | c-3 | 2.88 | A+ | A+ | A | A | A | A | A |
| | (D3197) | | | | | | | | |
| Example 2c | c-3 | 2.88 | A+ | A+ | A | A | A | A | A |
| | (D3197) | | | | | | | | |
| Example 3c | c-3 | 2.88 | A+ | A+ | A | A | A | A | A |
| | (D3197) | | | | | | | | |
| Example 4c | c-3 | 2.88 | A+ | A | A | A | A | A | A |
| | (D3197) | | | | | | | | |
| Example 5c | c-3 | 2.88 | A+ | B | B | A | A | A | A |
| | (D3197) | | | | | | | | |
| Example 6c | c-3 | 2.88 | A+ | A | B | A | A | A | A |
| | (D3197) | | | | | | | | |
| Reference | c-3 | 0.96 | A+ | A+ | A+ | A | A | C | A |
| Example 1c | (D3197) | | | | | | | | |
| Reference | c-3 | 0.96 | A+ | A+ | A+ | A | A | C | A |
| Example 2c | (D3197) | | | | | | | | |
| Reference | c-3 | 0.96 | A+ | A+ | A+ | A | A | C | A |
| Example 3c | (D3197) | | | | | | | | |
| Reference | c-3 | 0.96 | A+ | A | A | A | A | C | A |
| Example 4c | (D3197) | | | | | | | | |
| Reference | c-3 | 0.96 | A+ | A | A | A | A | C | A |
| Example 5c | (D3197) | | | | | | | | |
| Reference | c-3 | 2.88 | A+ | A | A | A | A | C | A |
| Example 6c | (D3197) | | | | | | | | |
| Reference | c-3 | 2.88 | A+ | A+ | A | A | A | C | A |
| Example 7c | (D3197) | | | | | | | | |
| Reference | c-3 | 0.96 | A+ | A+ | A+ | A | C | C | A |
| Example 8c | (D3197) | | | | | | | | |
| Reference | c-3 | 2.88 | A+ | C | C | A | A | A | A |
| Example 9c | (D3197) | | | | | | | | |
| Reference | c-3 | 0.96 | A+ | A | C | A | C | C | A |
| Example 10c | (D3197) | | | | | | | | |
| Comparative | c-4 | 2.88 | B | C | C | A | C | C | F |
| Example 1c | (T0366) | | | | | | | | |
| Comparative | c-4 | 0.96 | B | B | B | A | C | C | F |
| Example 2c | (T0366) | | | | | | | | |
| Comparative | c-4 | 2.88 | B | C | C | A | C | C | F |
| Example 3c | (T0366) | | | | | | | | |
| Comparative | c-4 | 0.96 | B | B | B | A | C | C | F |
| Example 4c | (T0366) | | | | | | | | |

*¹Solid ratio relative to 100 parts by mass of the solid content of the acrylic copolymer.

It is known that the pressure-sensitive adhesive sheets of Examples 1c to 6c and Reference Examples 1c to 10c are colorless before irradiation with UV rays and they take a short time for restoration to colorless and have a relative rapid rate of color change from colored to colorless. On the other hand, the pressure-sensitive adhesive sheets of Comparative Examples 1c to 4c were recognized to be already colored before irradiation with UV rays, and take a long time for restoration to colorless.

In addition, the pressure-sensitive adhesive sheets of Examples 1c to 6c were still prevented from being discolored even after exposed to FOM for 150 hours, and the results thereof are that the adhesive sheets can prevent them from being kept discolored all the time even in UV rays-free environments. Further, even after exposed to FOM for 50 hours, the pressure-sensitive adhesive sheets of these Examples were confirmed to be colored through UV irradiation and to keep photochromic performance, and it is known that the sheets have excellent weather resistance.

### INDUSTRIAL APPLICABILITY

The pressure-sensitive adhesive sheet having a pressure-sensitive adhesive layer formed of the pressure-sensitive adhesive composition of the present invention has a relatively rapid rate of color change from colored to colorless after termination of irradiation with UV rays, has excellent photochromic performance and can be a colorless pressure-sensitive adhesive sheet.

In addition, by controlling the structural units of the acrylic copolymer to be contained in the pressure-sensitive adhesive composition of the present invention and by controlling the type of the photochromic dye to be therein, the pressure-sensitive adhesive sheet formed of the composition can be given excellent weather resistance such that even after long-term outdoor use, the photochromic performance thereof is prevented from degrading and the sheet can be prevented from being kept discolored all the time in UV rays-free environments. Further, the pressure-sensitive adhesive sheet has a rapid rate of color change from colored to colorless after termination of irradiation with UV rays.

Consequently, the pressure-sensitive adhesive sheet of the present invention is stuck to glass and transparent resin plates for windowpanes, wall surfaces, partitions, to glass and transparent resin plates for illuminations to be used in space exposed to black light irradiation, to vehicles such as cars, buses, trans, etc., and to lenses such as those for sunglasses, eye glasses etc., for the purpose of light transmission control therethrough, and is favorable for use for outdoor-use or indoor-use color sheets.

### REFERENCE SIGNS LIST

1a, 1b, 1c Pressure-Sensitive Adhesive Sheet
11, 11′ Substrate
12 Pressure-Sensitive Adhesive Layer
13, 13′ Release Material

1. A pressure-sensitive adhesive composition comprising
an acrylic copolymer (A) having a structural unit (a1) derived from an alkyl (meth)acrylate (a1)′ and a structural unit (a2) derived from a functional group-containing monomer (a2)′,
a crosslinking agent (B), and
a photochromic dye (C) selected from a group consisting of dithienylethene-based compounds, oxazine-based compounds and naphthopyran-based compounds.

2. The pressure-sensitive adhesive composition according to claim 1, wherein the component (A) is an acrylic copolymer (A-1) having a structural unit (a1) derived from an alkyl (meth)acrylate (a1)′ and a structural unit (a2) derived from a functional group-containing monomer (a2)′,
wherein in (a2)′ a content of a structural unit derived from a carboxyl group-containing monomer and a content of a structural unit derived from a primary amino group-containing monomer are respectively 1.5% by mass or less, and
the component (C) is a dithienylethene-based compound with a content of from 0.40 to 8.00 parts by mass relative to 100 parts by mass of the acrylic copolymer (A-1).

3. The pressure-sensitive adhesive composition according to claim 2, wherein a content of the structural unit (a2) derived from the functional group-containing monomer (a2)′ in the acrylic copolymer (A-1) is from 0.01 to 35% by mass relative to all the structural units of the acrylic copolymer (A-1).

4. The pressure-sensitive adhesive composition according to claim 1, wherein the component (A) is an acrylic copolymer (A-2) having a structural unit (a1) derived from an alkyl (meth)acrylate (a1)′ and a structural unit (a2) derived from a functional group-containing monomer (a2)′,
wherein in (a2)′ a content of a structural unit derived from a carboxyl group-containing monomer and a content of a structural unit derived from a primary amino group-containing monomer are respectively 3.0% by mass or less, and
the component (C) is an oxazine-based compound with a content of from 0.40 to 8.00 parts by mass relative to 100 parts by mass of the acrylic copolymer (A-2).

5. The pressure-sensitive adhesive composition according to claim 4, wherein a content of the structural unit (a2) derived from the functional group-containing monomer (a2)′ in the acrylic copolymer (A-2) is from 0.01 to 35% by mass relative to all the structural units of the acrylic copolymer (A-2).

6. The pressure-sensitive adhesive composition according to claim 1, wherein the component (A) is an acrylic copolymer (A-3) having a structural unit (a1) derived from an alkyl (meth)acrylate (a1)′ and a structural unit (a2) derived from a functional group-containing monomer (a2)′,
wherein in (a2)′ a content of a structural unit derived from a carboxyl group-containing monomer is 8.0% by mass or less, a content of a structural unit derived from a primary amino group-containing monomer is 1.5% by mass or less, and a content of the structural unit (a2) is 0.5% by mass or more, and
the component (C) is a naphthopyran-based compound with a content of from 1.50 to 8.00 parts by mass relative to 100 parts by mass of the acrylic copolymer (A-3).

7. The pressure-sensitive adhesive composition according to claim 6, wherein a content of the structural unit (a1) is from 55 to 99.5% by mass and a content of the structural unit (a2) is from 0.5 to 35% by mass, relative to all the structural units of the acrylic copolymer (A-3).

8. The pressure-sensitive adhesive composition according to claim 1, wherein the functional group-containing monomer (a2)′ is a hydroxy group-containing monomer.

9. A pressure-sensitive adhesive sheet comprising a pressure-sensitive adhesive layer which comprises the pressure-sensitive adhesive composition of claim 1.

10. The pressure-sensitive adhesive composition according to claim 1, further comprising one or more additives selected from the group consisting of a tackifier, an antioxidant, a UV absorbent, a light stabilizer, a resin stabilizer, a filler, a pigment, a extender, an IR absorbent, a near-IR absorbent, an antiseptic/fungicide, a rust preventive, a plasticizer, and a high-boiling-point solvent.

11. The pressure-sensitive adhesive composition according to claim 1, wherein the crosslinking agent (B) is one or more selected from the group consisting of an isocyanate-based crosslinking agent, an epoxy-based crosslinking agent, an aziridine-based crosslinking agent, and a metal chelate-based crosslinking agent.

12. The pressure-sensitive adhesive composition according to claim 1, wherein the crosslinking agent (B) comprises from 0.01 to 8 parts by mass relative to 100 parts by mass of the component (A).
